(19) United States
(12) Patent Application Publication
(10) Pub. No.: US 2026/0086447 A1
(43) Pub. Date: Mar. 26, 2026

(54) OPTICAL MODULE AND PROJECTOR

(71) Applicant: SEIKO EPSON CORPORATION, Tokyo (JP)

(72) Inventors: Tomoya MIZUTANI, AZUMINO-SHI (JP); Masanori YASUDA, MATSUMOTO-SHI (JP)

(21) Appl. No.: 19/338,363

(22) Filed: Sep. 24, 2025

(30) Foreign Application Priority Data
Sep. 26, 2024 (JP) 2024-167633

(51) Int. Cl. G03B 21/20

(52) U.S. Cl. CPC G03B 21/2073; G03B 21/208

(57) ABSTRACT

An optical module according to an embodiment includes a first light source configured to output first light; a first light guide having a first light incident end and a first light exiting end, and configured to homogenize in-plane illuminance of the first light; a first parallelizing element configured to parallelize the first light; and a first light modulator configured to modulate the first light based on image information. The first light modulator includes a first polarization converter configured to change a polarization state of the first light, and a first polarization separator configured to transmit at least part of a first polarized component of the first light passing through the first polarization converter and reflect another part of the first light. The first polarization converter is configured to change a polarization state of the other part of the first light reflected off the first polarization separator.

The present application is based on, and claims priority from JP Application Serial Number 2024-167633, filed Sep. 26, 2024, the disclosure of which is hereby incorporated by reference herein in its entirety.

### BACKGROUND

### 1. Technical Field

The present disclosure relates to an optical module and a projector.

### 2. Related Art

There is a known projector of related art including a light source that outputs color light, a light modulation element that modulates the color light output from the light source to generate image light, and a projection system that projects the image light output from the light modulation element. Projectors are classified into a single-plate projector, a three-plate projector, and other types of projectors in accordance with the numbers of light sources and light modulation elements.

For example, JP-A-10-361256 discloses a projector including multiple light emitting diodes (LEDs) as light emitters of the light source. In a projector disclosed in JP-A-10-361256, multiple types of color light emitted from the LEDS pass through blocks, are then superimposed on one another on a path oriented in one direction, and the superimposed color light is modulated by a light modulation element into image light, which is projected by a projection lens. The brightness of the color light output from the light exit end of each of the blocks is homogenized in planes that intersect with the optical axis. The multiple types of color light output from the multiple blocks enter a cross-dichroic prism that combines the multiple types of light from the multiple LEDs with one another.

JP-A-10-361256 is an example of the related art.

The projector disclosed in JP-A-10-361256, when employing a light source that outputs color light containing all polarized components instead of color light containing only a specific polarized component, such as an LED, uses only the color light containing the specific polarized component to form an image, but does not need the color light containing the other polarized components other than the specific polarized component, so that the light use efficiency is poor. It is therefore required to take measures for improving the light use efficiency by making use of the color light output from the light source and containing the polarized components other than the specific polarized component.

### SUMMARY

An optical module according to an aspect of the present disclosure includes a first light source configured to output first light having a first wavelength band; a first light guide having a first light incident end on which the first light output from the first light source is incident and a first light exiting end via which the first light exits, and configured to homogenize in-plane illuminance of the first light; a first parallelizing element configured to parallelize the first light output from the first light guide; and a first light modulator configured to modulate the first light output from the first parallelizing element based on image information. The first light modulator includes a first polarization converter configured to change a polarization state of the first light output from the first parallelizing element, and a first polarization separator configured to transmit at least part of a first polarized component of the first light passing through the first polarization converter and reflect another part of the first light. The first polarization converter is configured to change a polarization state of the other part of the first light reflected off the first polarization separator.

### BRIEF DESCRIPTION OF THE DRAWINGS

FIG. 1 is a schematic view showing the configuration of a projector according to an embodiment.

FIG. 2 is a schematic view of a red light output portion and a light modulator that modulates red light in the projector shown in FIG. 1.

FIG. 3 is a schematic view of a retardation film of a light-incident-side polarizer of a light modulator in the red light output portion shown in FIG. 2.

FIG. 4 is a diagrammatic view showing the relationship between the crystal axis of a quartz crystal substrate constituting the retardation film of the light-incident-side polarizer of the light modulator shown in FIG. 2, which modulates the red light, and the transmission axis of a reflective polarizing layer.

FIG. 5 shows graphs illustrating an example of results of numerical calculation of the dependence of the amount of phase modulation on the wavelength of the red light, the amount of phase modulation being made by a single-plate quartz crystal substrate, which constitutes the retardation film of the light-incident-side polarizer of the light modulator shown in FIG. 2, which modulates the red light, and the spectrum of the red light.

FIG. 6 shows graphs illustrating an example of results of numerical calculation of the dependence of the amount of phase modulation on the wavelength of the red light, the amount of phase modulation being made by a bonded-two-piece quartz crystal substrate of the light-incident-side polarizer of the light modulator shown in FIG. 2, which modulates the red light, and the spectrum of the red light.

FIG. 7 is a schematic view of a green light output portion and a light modulator that modulates green light in the projector shown in FIG. 1.

FIG. 8 is a schematic view of a blue light output portion and a light modulator that modulates blue light in the projector shown in FIG. 1.

FIG. 9 shows graphs illustrating an example of results of numerical calculation of the dependence of the amount of phase modulation on the wavelength of the blue light, the amount of phase modulation being made by a single-plate quartz crystal substrate and a bonded-two-piece quartz crystal substrate, which each constitute a retardation film of a light-incident-side polarizer of the light modulator shown in FIG. 8, which modulates the blue light, and the spectrum of the blue light.

FIG. 10 shows diagrammatic graphs illustrating the ratio between S-polarized light and P-polarized light of the red light entering the reflective polarizing layer in the light-incident-side polarizer of the light modulator shown in FIG. 2, which modulates red light.

FIG. 11 shows diagrammatic graphs illustrating the ratio between S-polarized light and P-polarized light of red light entering a reflective polarizing layer in a light-incident-side polarizer of a light modulator that modulates the red light in a projector of related art.

### DESCRIPTION OF EMBODIMENTS

An embodiment of the present disclosure will be described below with reference to the drawings. In the drawings, elements are drawn at different dimensional scales in some cases for clarity of each of the elements.

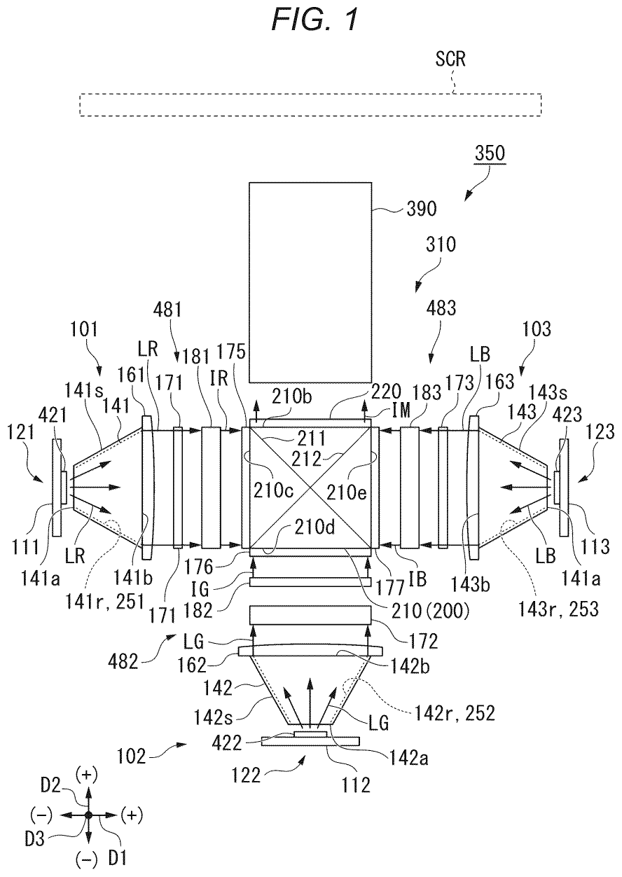

An embodiment of the present disclosure will first be described with reference to FIGS. 1 to 10. FIG. 1 is a schematic view showing the configuration of a projector 350 according to the embodiment of the present disclosure. The projector 350 is an image display apparatus including three liquid crystal panels as light modulators, and is what is called a three-plate projector.

The projector 350 includes an optical module 310 and a projection system 390, as shown in FIG. 1. The optical module 310 includes a red light output portion 101, a green light output portion 102, a blue light output portion 103, light modulators 481, 482, and 483, and a light combiner 200.

The red light output portion 101 outputs red light LR. In the following description, an axis parallel to the optical axis of the red light LR output from the red light output portion 101 is referred to as a D1 direction. One side in the D1 direction is referred to as a −D1 side, and the side opposite the −D1 side in the D1 direction is referred to as a +D1 side. The direction perpendicular to the D1 direction in a plane containing the optical axis of the red light LR is referred to as a D2 direction. One side in the D2 direction is referred to as a −D2 side, and the side opposite the −D2 side in the D2 direction is referred to as a +D2 side. The direction perpendicular to the D1 and D2 directions is referred to as a D3 direction. The red light LR output from the red light output portion 101 travels toward the +D1 side along the D1 direction.

The red light output portion 101 includes a light source 121, a light guide 141, and a parallelizing element 161. The light source 121 includes a substrate 111 and a light emitter 421. The light emitter 421 is provided at the +D1-side plate surface of the substrate 111 out of the plate surfaces thereof parallel to a plane containing the D2 and D3 directions. The light emission surface of the light emitter 421 is a surface located substantially in parallel to a plane containing the D2 and D3 directions, and being opposite, in the D1 direction, the surface of the light emitter 421 that is in contact with the +D1-side plate surface of the substrate 111.

The light source 121 corresponds to a first light source, and outputs the red light LR having a red wavelength band in the visible wavelength band. The red wavelength band corresponds to a first wavelength band. The red light LR corresponds to first light. The red light LR diverges from the light emission surface of the light source 121 in accordance with a predetermined radiation angle around the axis passing through the center of the light emission surface of the light source 121 and parallel to the D1 direction, and exits toward the +D1 side. The red wavelength band is, for example, a wavelength band ranging from 590 nm to 700 nm, and includes, for example, 630 nm.

The light emitter 421 corresponds to a first light emitter and is configured, for example, with an LED that emits the red light LR. The LED that emits the red light LR contains, for example, aluminum gallium indium phosphide (AlGaInP) having excellent light extraction efficiency as a light emitter. Note that the light emitter 421 may be configured with one LED or multiple LEDs in their entirety. When the light emitter 421 is configured with multiple LEDs, the multiple LEDs are arranged in the region occupied by the light emitter 421 in a plane containing the D2 and D3 directions.

Using an LED as the light source 121 suppresses the cost of the light source 121, and reduces speckle noise produced by the red light contained in image light IM to be projected onto a screen SCR.

The substrate 111 is made, for example, of metal, and also serves as a heat dissipation member that receives heat from the light emitter 421, which outputs the red light LR, and dissipates the heat to an external space.

The light guide 141 is provided in the optical path of the red light LR output from the light source 121, and is disposed on the +D1 side of the light source 121 at a position where the light guide 141 overlaps with the light source 121 in the D2 and D3 directions. The light guide 141 corresponds to a first light guide, and has a light incident end 141a facing the −D1 side in the D1 direction, a light exiting end 141b facing the +D1 side in the D1 direction, and side surfaces 141s and reflection surfaces 141r extending between the light incident end 141a and the light exiting end 141b in the D1 direction.

The light incident end 141a corresponds to a first light incident end and spreads in parallel to a plane containing the D2 and D3 directions. The shape of the light incident end 141a viewed in the D1 direction is the same as the shape of the light emission surface of the light source 121 viewed in the same direction, and is, for example, a quadrangular shape, specifically, a rectangular shape. The sizes of the light emission surface of the light source 121 in the D2 and D3 directions are each, for example, greater than or equal to 0.25 mm but smaller than or equal to 10 mm. The area of the light emission surface of the light source 121 viewed along the D1 direction ranges, for example, from 0.25 mm² to 10×10 mm².

The sizes of the light incident end 141a in a plane containing the D2 and D3 directions may be equal to the sizes of the light emission surface of the light source 121 in a plane containing the D2 and D3 directions, and are preferably appropriately greater than the sizes of the light emission surface of the light source 121 in the plane containing the D2 and D3 directions. A dimension of the opening through which the red light LR enters the light guide 141 at the light incident end 141a that is the dimension along the major sides of the opening that are parallel to the D2 direction is greater than or equal to 1 mm but smaller than or equal to 3 mm, for example, about 2 mm.

The light exiting end 141b corresponds to a first light exiting end, spreads in parallel to a plane containing the D2 and D3 directions, and is larger than the light incident end 141a. The shape of the light exiting end 141b viewed in the D1 direction is the same as the shape of the light modulation surface of a light modulation element 181 viewed in the same direction, and is, for example, a quadrangular shape. The sizes of the light exiting end 141b in a plane containing the D2 and D3 directions are equal to the sizes of the light modulation surface of the light modulation element 181 in a plane containing the D2 and D3 directions.

A dimension of the opening through which the red light LR exits out of the light guide 141 at the light exiting end 141b that is the dimension along the major sides of the opening that are parallel to the D2 direction is greater than or equal to 14 mm but smaller than or equal to 16 mm, for example, about 15 mm. The size of the light modulation surface of the light modulation element 181 in the major side direction, that is, the D2 direction is, for example, 15 mm. Note that the size of the light modulation surface of the light modulation element 181 may be selected as appropriate, for example, from values within a range from 6.48 mm×11.52 mm, which are the sizes of a 0.52-inch element, to 19.44 mm×34.56 mm, which are the sizes of a 1.5-inch element.

The side surfaces 141s and the reflection surfaces 141r couple the circumferential edge of the light incident end 141a to the circumferential edge of the light exiting end 141b in the D1 direction.

The red light LR output from the light source 121 enters the light guide 141 via the light incident end 141a. In the light guide 141, the internal space surrounded by the light incident end 141a, the light exiting end 141b, and the reflection surfaces 141r is a region in which the red light LR propagates. The sizes of the internal space of the light guide 141 in a plane containing the D2 and D3 directions increase as the internal space extends from the −D1 side toward the +D1 side in the D1 direction.

The cross-sectional area of the light exiting end 141b of the light guide 141 that contains the D2 and D3 directions, that is, the area occupied by the cross section of the light exiting end 141b that is parallel to a plane perpendicular to the center axis of the light guide 141 that is parallel to the D1 direction is greater than the cross-sectional area of the light incident end 141a of the light guide 141 that contains the same directions, that is, the area occupied by the cross section of the light incident end 141a of the light guide 141 that is parallel to the plane perpendicular to the center axis of the light guide 141. The area occupied by the cross section perpendicular to the center axis of the light guide 141 increases as the light guide 141 extends from the light incident end 141a toward the light exiting end 141b.

The shape of the internal space of the light guide 141 in a plane containing the D2 and D3 directions changes from the shape of the light emission surface of the light source 121 viewed in the D1 direction to the shape of the light modulation surface of the light modulation element 181 as the internal space extends from the −D1 side toward the +D1 side.

The side surfaces 141s of the light guide 141 and the reflection surfaces 141r provided at the side surfaces 141s as will be described later incline by a predetermined angle with respect to an imaginary line perpendicular to the light incident end 141a and the center axis of the light guide 141, and are separated away from the imaginary line in a plane containing the D2 and D3 directions as the light guide 141 extends from the −D1 side toward the +D1 side. The red light LR that enters the light guide 141 propagates through the internal space of the light guide 141 from the −D1 side toward the +D1 side.

The light modulation surface of the light modulation element 181 viewed along the D1 direction has a quadrangular and rectangular shape, and the light emission surface of the light source 121 viewed along the D1 direction has a rectangular shape. A predetermined angle, that is, taper angle by which the side surfaces 141s and the reflection surfaces 141r containing the minor sides of the rectangular shape that are parallel to the D3 direction incline with respect to the imaginary line described above and the center axis of the light guide 141 is, for example, greater than or equal to 7° but smaller than or equal to 22°. A predetermined angle, that is, a taper angle by which the side surfaces 141s and the reflection surfaces 141r containing the major sides of the rectangular shape that are parallel to the D2 direction incline with respect to the imaginary line described above and the center axis of the light guide 141 is, for example, greater than or equal to 14° but smaller than or equal to 36°. A preferable range of the taper angle is so set as appropriate that reflection films 251 of the light guide 141 have desired reflectance derived by a numerical simulation based on the configuration of the red light output portion 101 and ray tracing.

Part of the red light LR having entered the light guide 141 inclines by angles smaller than the predetermined taper angle with respect to the imaginary line described above and the center axis of the light guide 141, and propagates directly from the light incident end 141a to the light exiting end 141b without being incident even once on the reflection surfaces 141r. The remainder of the red light LR having entered the light guide 141 inclines by angles greater than or equal to the predetermined taper angle with respect to the imaginary line described above and the center axis of the light guide 141, is incident on the reflection surfaces 141r via the light incident end 141a once or a greater number of times, is reflected off the reflection surfaces 141r, and then reaches the light exiting end 141b. The paths of the beams constituting the red light LR in the internal space of the light guide 141 vary in accordance with the angles of incidence of the beams incident on the light incident end 141a, and there are multiple paths along which the beams are reflected off the reflection surfaces 141r by different numbers of times.

The illuminance distribution of the red light LR propagating in the internal space of the light guide 141 toward the +D1 side is homogenized in planes containing the D2 and D3 directions. That is, the light guide 141 homogenizes the illuminance distribution of the incident red light LR in the planes containing the D2 and D3 directions. The red light LR having the homogenized illuminance distribution exits via the light exiting end 141b toward the +D1 side.

The light guide 141 is, for example, a reflector and is formed as a hollow member. The light guide 141 is formed, for example, in a quadrangular shape when viewed along the D1 direction, and is tapered from the light exiting end 141b toward the light incident end 141a. When viewed along the D1 direction, the −D1 side end of a frame body of the reflector has the same shape and size as the light incident end 141a and the light emission surface of the light source 121, and the +D1 side end of the frame body of the reflector has the same shape and size as the light exiting end 141b and the light modulation surface of the light modulation element 181, and is formed, for example, in a quadrangular shape having a size different from that of the −D1 side end of the frame body of the reflector.

The light guide 141 is configured, for example, with plate-shaped members and the reflection films 251. When the light incident end 141a and the light exiting end 141b have quadrangular shapes when viewed in the D1 direction, the reflector is configured, for example, with four plate-shaped members each having a trapezoidal shape and the reflection films 251. The light guide 141 is configured, for example, with the four plate-shaped members each having a trapezoidal shape with the sides corresponding to the legs of the trapezoidal shape coupled to each other.

The width, that is, the dimension of each of the sides facing the −D1 side that are parallel to the D2 or D3 direction and correspond to the upper bases of the four plate-shaped members of the light guide 141 is set in accordance with the size of the light incident end 141a and the light emission surface of the light source 121 in the D2 or D3 direction. The width, that is, the dimension of each of the sides facing the +D1 side that are parallel to the D2 or D3 direction and correspond to the lower bases of the four plate-shaped members of the light guide 141 is set in accordance with the size of the light exiting end 141b and the light modulation surface of the light modulation element 181 in the D2 or D3 direction.

In consideration of the size and the like of the light source 121, the width of each of the −D1-side end sides of two of the four plate-shaped members that are parallel to the D2 direction is greater than or equal to 1 mm but smaller than or equal to 3 mm, for example, about 2 mm. Similarly, the width of each of the +D1-side end sides of the two plate-shaped members that are parallel to the D2 direction is greater than or equal to 14 mm but smaller than or equal to 16 mm, for example, about 15 mm. The length of each of the four plate-shaped members from the light incident end 141a to the light exiting end 141b in the D1 direction is greater than or equal to 5 mm but shorter than or equal to 25 mm.

The material of the four plate-shaped members of the light guide 141 contains at least any of aluminum (Al) and silver (Ag), which are metals, and glass, that is, silicon dioxide (SiO₂), which is a transparent material.

To increase the reflectance in the vicinity of the side surfaces 141s for the red light LR having entered the light guide 141 via the light incident end 141a, the light guide 141 is provided with the reflection films 251 each configured with a dielectric multilayer film or the like at plate surfaces of the four plate-shaped members constituting the reflector that are plate surfaces facing the internal space of the light guide 141. Part of the red light LR having entered the internal space of the light guide 141 via the light incident end 141a is reflected off the reflection films 251 and travels toward the +D1 side.

The intensity of the red light LR reflected off the reflection films 251 and output from the reflection films 251 depends in some cases on the angle of incidence of the red light LR incident on the reflection films 251. When the reflection films 251 are each configured with a dielectric multilayer film, the dependence of the intensity of the red light LR output from the reflection films 251 on the angle of incidence of the red light LR changes in accordance, for example, with the numbers of the low refractive index layers and the high refractive index layers constituting the dielectric multilayer film, the refractive index of the low refractive index layers, the refractive index of the high refractive index layers, the difference in the refractive index between the low refractive index layers and the high refractive index layers, and other parameters. When the reflection films 251 are each configured with a metal film, the dependence of the intensity of the red light LR output from the reflection films 251 on the angle of incidence of the red light LR changes in accordance, for example, with the density of metal particles and other parameters.

For example, the visibility of an image projected by the projector 350 is enhanced by setting the wavelength at which the spectral reflectance of the reflection films 251 is maximized to a wavelength of about 555 nm, at which the human visibility is maximized. Adjusting the parameters of the dielectric multilayer film or the metal film constituting each of the reflection films 251 allows favorable control of the wavelength at which the reflectance of the reflection films 251 is maximized.

As described above, for example, when the taper angle of the light guide 141 is greater than or equal to 7° but smaller than or equal to 22°, or greater than or equal to 14° but smaller than or equal to 36°, the reflection films 251 are so designed that the angle of incidence of the red light LR at which the intensity of the red light LR output from the reflection surfaces 141r is maximized falls within a predetermined angular range, and the total number of each of the low refractive index layers and the high refractive index layers constituting the dielectric multilayer film, the difference in the refractive index between the low refractive index layers and the high refractive index layers, and other parameters are determined as appropriate. The predetermined angular range ranges, for example, from 60° to 90°. The relationship between the angle of incidence of the red light LR incident on the reflection surfaces 141r and the reflection films 251 and the intensity of the red light LR output from the reflection surface 141r and the reflection films 251 is derived by the numerical simulation based on the configuration of the red light output portion 101 and the ray tracing.

The parallelizing element 161 is provided in the optical path of the red light LR output from the light guide 141, and is disposed at a position which is shifted toward the +D1 side from the light guide 141 and where the parallelizing element 161 overlaps with the light guide 141 in the D2 and D3 directions. The parallelizing element 161 parallelizes along the D1 direction the red light LR output from the light guide 141. The parallelizing element 161 corresponds to a first parallelizing element.

The parallelizing element 161 is, for example, a planoconvex lens, and has a light incident surface configured with a planar surface perpendicular to the D1 direction, and a light exiting surface configured with a convex curved surface protruding toward the side via which the red light LR exits. The focal point of the planoconvex lens constituting the parallelizing element 161 is disposed at least on the −D1 side of the parallelizing element 161, and on the side opposite the +D1 side, where the red light LR is output from the parallelizing element 161, and further on the −D1 side of the light guide 141.

The light incident surface of the planoconvex lens constituting the parallelizing element 161 is in contact with the light exiting end 141b of the light guide 141. Since the parallelizing element 161 is in contact with the light exiting end 141b, the red light LR output via the light exiting end 141b of the light guide 141 and taken into the parallelizing element 161 is maximized, so that loss of the red light LR can be suppressed. Note, however, that the parallelizing element 161 may be an optical lens different from a planoconvex lens but capable of parallelizing the incident red light LR, and may be disposed at an appropriate distance from the light guide 141 in the D1 direction.

The light modulator 481 includes a light-incident-side polarizer 171, the light modulation element 181, and a light-exiting-side polarizer 175. The light modulator 481 corresponds to a first light modulator and modulates the incident red light LR based on image information transmitted from an image formation apparatus such as a computer that is not shown but is disposed outside the projector 350.

The light-incident-side polarizer 171 is provided in the optical path of the red light LR output from the parallelizing element 161, and is disposed at a position which is shifted toward the +D1 side from the parallelizing element 161 and where the light-incident-side polarizer 171 overlaps with the parallelizing element 161 in the D2 and D3 directions. The light-incident-side polarizer 171 is disposed, for example, at an appropriate distance from the light modulation element 181 in the D1 direction, and may instead be in contact with the light modulation element 181 on the −D1 side. The light-incident-side polarizer 171 outputs predetermined polarized light toward the +D1 side along the D1 direction out of the red light LR output from the parallelizing element 161. The predetermined polarized light is, for example, S polarized light.

The light-incident-side polarizer 171 includes, for example, a reflective polarizing layer having plate surfaces parallel to a plane containing the D2 and D3 directions. The light-incident-side polarizer 171 transmits part of the incident red light LR that is red light LR containing the predetermined polarized light toward the +D1 side, and reflects the other part of the red light LR toward the −D1 side.

The red light LR output from the light source 121 contains at least P polarized light and S polarized light and is, for example, randomly polarized light. The P-polarized component of the red light LR output from the light source 121 sequentially passes through the light guide 141 and the parallelizing element 161 as described above, passes through the light-incident-side polarizer 171, and exits out of the light-incident-side polarizer 171 toward the +D1 side. The S-polarization component of the red light LR sequentially passes through the light guide 141 and the parallelizing element 161 as the P-polarized component, but is reflected off the light incident surface of the light-incident-side polarizer 171 and is output out of the light-incident-side polarizer 171 toward the −D1 side.

The light modulation element 181 is provided in the optical path of the red light LR output from the light-incident-side polarizer 171, and is disposed at a position which is shifted toward the +D1 side from the light-incident-side polarizer 171 and where the light modulation element 181 overlaps with the light-incident-side polarizer 171 in the D2 and D3 directions. The light modulation element 181 modulates the red light LR output from the light-incident-side polarizer 171 based on image information transmitted from the image formation apparatus, which is not shown but is externally coupled to the light modulation element 181.

The light modulation element 181 is, for example, a transmissive liquid crystal panel. The liquid crystal panel constituting the light modulation element 181 has multiple pixels that are not shown. The pixels each include a switching element. The switching element is, for example, a polysilicon thin film transistor (TFT). The switching element in each of the pixels receives an electric signal according to the brightness of the red light at a relative position in an image projected by the projector 350 with respect to the pixel at the light modulation surface of the light modulation element 181. The pixels each modulate the vibration direction of the red light LR incident from the light-incident-side polarizer 171 with the aid of the operation of the switching element according to the electric signal described above to generate red image light IR. The image light IR corresponds to second light. The light modulation element 181 outputs the image light IR generated by the liquid crystal panel toward the +D1 side along the D1 direction.

The light-exiting-side polarizer 175 is provided in the optical path of the image light IR output from the light modulation element 181, and is disposed at a position which is shifted toward the +D1 side from the light modulation element 181 and where the light-exiting-side polarizer 175 overlaps with the light modulation element 181 in the D2 and D3 directions. For example, the light-exiting-side polarizer 175 is in contact from the −D1 side with a light incident surface of the light combiner 200, that is the surface on which the image light IR is incident, that is, a light incident surface 210c of a cross dichroic prism 210, which will be described later, and may instead be disposed at appropriate distances from the light modulation element 181 and the light combiner 200 in the D1 direction. The light-exiting-side polarizer 175 converts the image light IR output from the light modulation element 181 into circularly polarized image light IR and outputs the circularly polarized image light IR toward the +D1 side along the D1 direction.

The light-exiting-side polarizer 175 is, for example, a reflective or absorptive polarizer plate having plate surfaces parallel to a plane containing the D2 and D3 directions. The light-exiting-side polarizer 175 transmits part of the incident image light IR that is image light IR containing the predetermined polarized light toward the +D1 side, and reflects or absorbs the other part of the image light IR toward the −D1 side. Note that when it is desired to suppress generation of return light and stray light directed to the light modulation element 181, it is desirable to employ an absorptive polarizer plate as the light-exiting-side polarizer 175.

The light-incident-side polarizer 171, the light modulation element 181, and the light-exiting-side polarizer 175 of the light modulator 481 will each be described later in detail.

The green light output portion 102 is disposed at a position shifted toward the +D1 side and the −D2 side from the red light output portion 101 in a region where the green light output portion 102 overlaps with the red light output portion 101 in the D3 direction. The green light output portion 102 outputs green light LG. The green light LG output from the green light output portion 102 travels toward the +D2 side along the D2 direction.

The green light output portion 102 includes a light source 122, a light guide 142, and a parallelizing element 162. The light source 122 includes a substrate 112 and a light emitter 422. The light emitter 422 is provided at the +D2-side plate surface of the substrate 112 out of the plate surfaces thereof parallel to a plane containing the D1 and D3 directions. The light emission surface of the light emitter 422 is a surface located substantially in parallel to a plane containing the D1 and D3 directions, and being opposite, in the D2 direction, the surface of the light emitter 422 that is in contact with the +D2-side plate surface of the substrate 112.

The light source 122 corresponds to a third light source, and outputs the green light LG having a green wavelength band in the visible wavelength band. The green wavelength band corresponds to a third wavelength band. The green light LG corresponds to third light. Unlike the red wavelength band, the green wavelength band is, for example, a wavelength band ranging from 500 nm to 590 nm, and includes, for example, 532 nm.

The light emitter 422 includes, for example, an LED that emits the green light LG. In the green light output portion 102, to optimize the green wavelength band and the intensity of the green light LG with respect to the red wavelength band and the intensity of red light LR output from the red light output portion 101 and a blue wavelength band and the intensity of blue light LB output from the blue light output portion 103, the light emitter 422 is configured, for example, with a phosphor containing LED.

The light emitter 422 is provided at the +D2-side plate surface of the substrate 112. The light emitter 422 may, for example, be an LED that emits blue light having the blue wavelength band as the LED of a light source 123. The light emitter 422 includes a LED body, so that the cost of the light source 122 is reduced, and the speckle noise produced by the green light contained in the image light IM is reduced.

Note that the light emitter 422 may be configured with one LED or multiple LEDs in their entirety, as the light emitter 421. When the light emitter 422 is configured with multiple LEDs, the multiple LEDs are arranged in the region occupied by the light source 122 in a plane containing the D1 and D3 directions.

The substrate 112 is made, for example, of metal, and also serves as a heat dissipation member that receives heat from the light emitter 422, which outputs the green light LG, and dissipates the heat to an external space.

The light guide 142 is provided in the optical path of the green light LG output from the light source 122, and is disposed on the +D2 side of the light source 122 at a position where the light guide 142 overlaps with the light source 122 in the D1 and D3 directions. The light guide 142 corresponds to a third light guide, and has a light incident end 142a facing the −D2 side in the D2 direction, a light exiting end 142b facing the +D2 side in the D2 direction, and side surfaces 142s and reflection surfaces 142r extending between the light incident end 142a and the light exiting end 142b in the D2 direction.

The light incident end 142a corresponds to a third light incident end and spreads in parallel to a plane containing the D1 and D3 directions. The shape of the light incident end 142a viewed in the D2 direction is the same as the shape of the light emission surface of the light source 122 viewed in the same direction, and is, for example, a quadrangular shape, specifically, a rectangular shape. The sizes of the light emission surface of the light source 122 in the D1 and D3 directions are each, for example, greater than or equal to 0.25 mm but smaller than or equal to 10 mm. The area of the light emission surface of the light source 122 viewed along the D2 direction ranges, for example, from 0.25 mm² to 10×10 mm².

The sizes of the light incident end 142a in a plane containing the D1 and D3 directions may be equal to the sizes of the light emission surface of the light source 122 in a plane containing the D1 and D3 directions, and are preferably appropriately greater than the sizes of the light emission surface of the light source 122 in the plane containing the D1 and D3 directions. A dimension of the opening through which the green light LG enters the light guide 142 at the light incident end 142a that is the dimension along the major sides of the opening that are parallel to the D1 direction is greater than or equal to 1 mm but smaller than or equal to 3 mm, preferably, about 2 mm.

The light exiting end 142b corresponds to a third light exiting end, spreads in parallel to a plane containing the D1 and D3 directions, and is larger than the light incident end 142a. The shape of the light exiting end 142b viewed in the D2 direction is the same as the shape of the light modulation surface of a light modulation element 182 viewed in the same direction, and is, for example, a quadrangular shape. The sizes of the light exiting end 142b in a plane containing the D1 and D3 directions are equal to the sizes of the light modulation surface of the light modulation element 182 in a plane containing the D1 and D3 directions.

A dimension of the opening through which the green light LG exits out of the light guide 142 at the light exiting end 142b that is the dimension along the major sides of the opening that are parallel to the D1 direction is greater than or equal to 14 mm but smaller than or equal to 16 mm, for example, about 15 mm. Note that the size of the light modulation surface of the light modulation element 182 may be selected as appropriate, for example, from values within the range from 6.48 mm×11.52 mm, which are the sizes of a 0.52-inch element, to 19.44 mm×34.56 mm, which are the sizes of a 1.5-inch element.

The side surfaces 142s and the reflection surfaces 142r couple the circumferential edge of the light incident end 142a to the circumferential edge of the light exiting end 142b in the D2 direction.

The green light LG output from the light source 122 enters the light guide 142 via the light incident end 142a. In the light guide 142, the internal space surrounded by the light incident end 142a, the light exiting end 142b, and the reflection surfaces 142r is a region in which the green light LG propagates. The size of the internal space of the light guide 142 in a plane containing the D1 and D3 directions increases as the internal space extends from the −D2 side toward the +D2 side in the D2 direction.

The cross-sectional area of the light exiting end 142b of the light guide 142 that contains the D1 and D3 directions, that is, the area occupied by the cross section of the light exiting end 142b that is parallel to a plane perpendicular to the center axis of the light guide 142 that is parallel to the D2 direction is greater than the cross-sectional area of the light incident end 142a of the light guide 142 that contains the same directions, that is, the area occupied by the cross section of the light incident end 142a of the light guide 142 that is parallel to the plane perpendicular to the center axis of the light guide 142. The area occupied by the cross section perpendicular to the center axis of the light guide 142 increases as the light guide 142 extends from the light incident end 142a toward the light exiting end 142b.

The shape of the internal space of the light guide 142 in a plane containing the D1 and D3 directions changes from the shape of the light emission surface of the light source 122 viewed in the D2 direction to the shape of the light modulation surface of the light modulation element 182 as the internal space extends from the −D2 side toward the +D2 side.

The side surfaces 142s of the light guide 142 and the reflection surfaces 142r provided at the side surfaces 142s as will be described later incline by a predetermined angle with respect to an imaginary line perpendicular to the light incident end 142a and the center axis of the light guide 142, and are separated away from the imaginary line in a plane containing the D1 and D3 directions as the light guide 142 extends from the −D2 side toward the +D2 side. The green light LG that enters the light guide 142 propagates through the internal space of the light guide 142 from the −D2 side toward the +D2 side.

The light modulation surface of the light modulation element 182 viewed along the D2 direction has a quadrangular and rectangular shape, and the light emission surface of the light source 122 viewed along the D2 direction has a rectangular shape. A predetermined angle, that is, a taper angle by which the side surfaces 142s and the reflection surfaces 142r containing the minor sides of the rectangular shape that are parallel to the D2 direction incline with respect to the imaginary line and the center axis of the light guide 142 is, for example, greater than or equal to 7° but smaller than or equal to 22°. A predetermined angle, that is, a taper angle of the side surfaces 142s and the reflection surfaces 142r containing the major sides of the rectangular shape that are parallel to the D1 direction with respect to the imaginary line described above and the center axis of the light guide 142 is, for example, greater than or equal to 14° but smaller than or equal to 36°. A preferable range of the taper angle is so set as appropriate that reflection films 252 of the light guide 142 have desired reflectance derived by a numerical simulation based on the configuration of the green light output portion 102 and ray tracing.

The beams of part of the green light LG having entered the light guide 142 incline by angles smaller than the predetermined taper angle with respect to the imaginary line and the center axis of the light guide 142, and propagate directly from the light incident end 142a to the light exiting end 142b without being incident even once on the reflection surfaces 142r. The beams of the remainder of the green light LG having entered the light guide 142 incline by angles greater than or equal to the predetermined taper angle with respect to the imaginary line and the center axis of the light guide 142, are incident on the reflection surfaces 142r via the light incident end 142a once, are reflected off the reflection surfaces 142r, and then reach the light exiting end 142b. The beams excluding the beams of the remainder of the green light LG having entered the light guide 142 are incident via the light incident end 142a on the reflection surfaces 142r twice or a greater number of times, are repeatedly reflected off the reflection surfaces 142r, and then reach the light exiting end 142b.

The paths of the beams constituting the green light LG in the internal space of the light guide 142 vary in accordance with the angles of incidence of the beams incident on the light incident end 142a, and there are multiple paths along which the beams are reflected off the reflection surfaces 142r by different numbers of times. The illuminance distribution of the green light LG propagating in the internal space of the light guide 142 is thus homogenized in planes containing the D1 and D3 directions. That is, the light guide 142 homogenizes the illuminance distribution of the incident green light LG in the planes containing the D1 and D3 directions. The green light LG having the homogenized illuminance distribution exits via the light exiting end 142b toward the +D2 side.

The light guide 142 is a hollow reflector configured, for example, with plate-shaped members, as the light guide 141. The light guide 142 is formed, for example, in a quadrangular shape when viewed along the D2 direction, and is tapered from the light exiting end 142b toward the light incident end 142a. When viewed along the D2 direction, the −D2-side end of the frame body of the reflector has the same shape and size as the light incident end 142a and the light emission surface of the light source 122, and is formed, for example, in a quadrangular shape. The +D2-side end of the frame body of the reflector has the same shape and size as the light exiting end 142b and the light modulation surface of the light modulation element 182, and is formed, for example, in a quadrangular shape having a size different from that of the −D2 side end of the frame body of the reflector.

The light guide 142 is configured with the plate-shaped members and the reflection films 252. The light guide 142 is configured, for example, with the four plate-shaped members each having a trapezoidal shape with the sides corresponding to the legs of the trapezoidal shape coupled to each other. The width, that is, the dimension of each of the sides facing the −D2 side that are parallel to the D1 or D3 direction and correspond to the upper bases of the four plate-shaped members is set in accordance with the size of the light incident end 142a and the light emission surface of the light source 122 in the D1 or D3 direction. The width, that is, the dimension of each of the sides facing the +D2 side that are parallel to the D1 or D3 direction and correspond to the lower bases of the four plate-shaped members of the light guide 142 is set in accordance with the size of the light exiting end 142b and the light modulation surface of the light modulation element 182 in the D1 or D3 direction.

In consideration of the size and the like of the light source 122, the width, that is the dimension of each of the −D2-side end sides of two plate-shaped members facing each other out of the four plate-shaped members that are parallel to the D1 direction is greater than or equal to 1 mm but smaller than or equal to 3 mm, for example, about 2 mm. The width, that is, the dimension of each of the +D2-side end sides of the two of the plate-shaped members out of the four plate-shaped members that are parallel to the D1 direction is greater than or equal to 14 mm but smaller than or equal to 16 mm, for example, about 15 mm. The length of each of the four plate-shaped members from the light incident end 142a to the light exiting end 142b in the D2 direction is, for example, greater than or equal to 5 mm but shorter than or equal to 25 mm. The shape of the light guide 142 is the same as the shape of the light guide 141.

The material of the four plate-shaped members of the light guide 142 contains at least any of Al, Ag, and glass, that is, SiO₂, and is, for example, the same as the material of the plate-shaped members of the light guide 141.

To increase the reflectance in the vicinity of the side surface 142s for the green light LG having entered the light guide 142 via the light incident end 142a, the reflector, that is, the light guide 142 is provided with the reflection films 252 each configured with a dielectric multilayer film or the like at plate surfaces opposite the side surfaces 142s of the plate-shaped members constituting the reflector, that is, the plate surfaces facing the internal space of the light guide 142. The beams of part of the green light LG, which include the beams that enter the internal space of the light guide 142 via the light incident end 142a, are reflected off the reflection films 252 and travel toward the +D2 side.

The intensity of the green light LG reflected off the reflection films 252 and output from the reflection films 252 depends in some cases on the angle of incidence of the green light LG incident on the reflection films 252. When the reflection films 252 are each configured with a dielectric multilayer film, the dependence of the intensity of the green light LG output from the reflection films 252 on the angle of incidence of the green light LG changes in accordance, for example, with the numbers of the low refractive index layers and the high refractive index layers constituting the dielectric multilayer film, the refractive index of the low refractive index layers, the refractive index of the high refractive index layers, the difference in the refractive index between the low refractive index layers and the high refractive index layers, and other parameters. When the reflection films 252 are each configured with a metal film, the dependence of the intensity of the green light LG output from the reflection films 252 on the angle of incidence of the green light LG changes in accordance, for example, with the density of metal particles and other parameters.

For example, the visibility of an image projected by the projector 350 is enhanced by setting the wavelength at which the spectral reflectance of the reflection films 252 is maximized to a wavelength at which the human visibility is maximized. Adjusting the parameters of the dielectric multilayer film or the metal film constituting each of the reflection films 252 allows favorable control of the wavelength at which the reflectance of the reflection films 252 is maximized.

In the light guide 142, for example, when the taper angle of the light guide 142 is greater than or equal to 7° but smaller than or equal to 22° or greater than or equal to 14° but smaller than or equal to 36°, the reflection films 252 are so designed that the angle of incidence of the green light LG at which the intensity of the green light LG output from the reflection surfaces 142r and the reflection films 252 is maximized falls within a predetermined angular range, and parameters of the dielectric multilayer film are determined as appropriate. The predetermined angular range ranges, for example, from 60° to 90°. The relationship between the angle of incidence of the green light LG to be incident on the reflection films 252 and the intensity of the green light LG output from the reflection films 252 is also derived by the numerical simulation based on the configuration of the green light output portion 102 and the ray tracing.

The parallelizing element 162 is provided in the optical path of the green light LG output from the light guide 142, and is disposed at a position which is shifted toward the +D2 side from the light guide 142 and where the parallelizing element 162 overlaps with the light guide 142 in the D1 and D3 directions. The parallelizing element 162 parallelizes the green light LG output from the light guide 142 along the D2 direction. The parallelizing element 162 corresponds to a second parallelizing element.

The parallelizing element 162 is, for example, a planoconvex lens, and has a light incident surface configured with a planar surface perpendicular to the D2 direction, and a light exiting surface configured with a convex curved surface protruding toward the side via which the green light LG exits. The focal point of the planoconvex lens constituting the parallelizing element 162 is at least on the −D2 side of the parallelizing element 162, and on the side opposite the +D2 side, where the green light LG is output from the parallelizing element 162, and further on the −D2 side of the light guide 142.

The light incident surface of the parallelizing element 162 is in contact with the light exiting end 142b of the light guide 142. Since the parallelizing element 162 is in contact with the light exiting end 142b, the green light LG output via the light exiting end 142b of the light guide 142 taken into the parallelizing element 162 is maximized, so that loss of the green light LG can be suppressed. Note, however, that the parallelizing element 162 may be an optical lens different from a planoconvex lens but capable of parallelizing the incident green light LG, and may be disposed at an appropriate distance from the light guide 142 in the D2 direction.

The light modulator 482 includes a light-incident-side polarizer 172, the light modulation element 182, and a light-exiting-side polarizer 176. The light modulator 482 corresponds to a third light modulator and modulates the incident green light LG based on image information transmitted from the image formation apparatus such as a computer that is not shown but is disposed outside the projector 350.

The light-incident-side polarizer 172 is provided in the optical path of the green light LG output from the parallelizing element 162, and is disposed at a position which is shifted toward the +D2 side from the parallelizing element 162 and where the light-incident-side polarizer 172 overlaps with the parallelizing element 162 in the D1 and D3 directions. The light-incident-side polarizer 172 is disposed, for example, at an appropriate distance from the light modulation element 182 in the D2 direction, and may instead be in contact with the −D2 side of the light modulation element 182. The light-incident-side polarizer 172 outputs predetermined polarized light toward the +D2 side along the D2 direction out of the green light LG output from the parallelizing element 162. The predetermined polarized light is, for example, P polarized light.

The light-incident-side polarizer 172 is, for example, a reflective polarizer plate having plate surfaces parallel to a plane containing the D1 and D3 directions. The light-incident-side polarizer 172 transmits part of the incident green light LG that is green light LG containing the predetermined polarized light toward the +D2 side, and reflects the other part of the green light LG toward the −D2 side. When the light source 122 includes a phosphor as in the green light output portion 102, the light reflected off the reflective polarizer plate can be used to excite the phosphor, and it is therefore desirable that the light-incident-side polarizer 172 is a reflective polarizer plate.

The green light LG output from the light source 122 is randomly polarized light containing at least P polarized light and S polarized light. The green light LG output from the light source 122 and containing the S-polarized component and the P-polarized component passes through the light guide 142, which homogenizes the illuminance distribution of the green light LG in a plane containing the D1 and D3 directions, and the homogenized green light LG exits out of the light guide 142 toward the +D2. The green light LG passes through the parallelizing element 162 and is parallelized by the parallelizing element 162.

The parallelized green light LG enters the light-incident-side polarizer 172 from the −D2 side. The P-polarized component out of the green light LG passes through the light-incident-side polarizer 172 and exits out of the light-incident-side polarizer 172 toward the +D2 side. The S-polarized component of the green light LG is reflected off the light incident surface of the light-incident-side polarizer 172 and exits out of the light-incident-side polarizer 172 toward the −D2 side.

The green light LG reflected off the light-incident-side polarizer 172 toward the −D2 side sequentially passes through the parallelizing element 162 and the light guide 142, travels toward the −D2 side along the D2 direction, is collected in planes containing the D1 and D3 directions, and enters the phosphor in the light source 122 from the +D2 side. The phosphor is excited again by the S-polarized component of the green light LG output from the light-incident-side polarizer 172 toward the −D2 side, and emits the green light LG containing the S-polarized and P-polarized components again via the light exiting surface of the phosphor toward the +D2 side.

Since the light-incident-side polarizer 172 is configured with a reflective polarizer plate, the polarized green light LG that does not pass through the light-incident-side polarizer 172 enters again the phosphor in the light source 122, and contributes to the excitation of and the light emission from the phosphor.

The light modulation element 182 is provided in the optical path of the green light LG output from the light-incident-side polarizer 172, and is disposed at a position which is shifted toward the +D2 side from the light-incident-side polarizer 172 and where the light modulation element 182 overlaps with the light-incident-side polarizer 172 in the D1 and D3 directions. The light modulation element 182 modulates the green light LG output from the light-incident-side polarizer 172 based on image information transmitted from the image formation apparatus that is not shown but is externally coupled to the light modulation element 182.

The light modulation element 182 is, for example, a transmissive liquid crystal panel. The liquid crystal panel constituting the light modulation element 182 has multiple pixels that are not shown. The pixels each include a switching element. The switching element is, for example, a TFT. The switching element in each of the pixels receives an electric signal according to the brightness of the green light at a relative position in an image projected by the projector 350 with respect to the pixel at the light modulation surface of the light modulation element 182. The pixels each modulate the vibration direction of the green light LG incident from the light-incident-side polarizer 172 with the aid of the operation of the switching element according to the electric signal described above to generate green image light IG. The image light IG corresponds to the third light. The light modulation element 182 outputs the image light IG generated by the liquid crystal panel toward the +D2 side along the D2 direction.

The light-exiting-side polarizer 176 is provided in the optical path of the image light IG output from the light modulation element 182, and is disposed at a position which is shifted toward the +D2 side from the light modulation element 182 and where the light-exiting-side polarizer 176 overlaps with the light modulation element 182 in the D1 and D3 directions. For example, the light-exiting-side polarizer 176 is in contact from the −D2 side with the light incident surface of the light combiner 200, which is the surface on which the image light IG is incident, that is, a light incident surface 210d of the cross dichroic prism 210, which will be described later, and may instead be disposed at appropriate distances from the light modulation element 182 and the light combiner 200 in the D2 direction. The light-exiting-side polarizer 176 converts the image light IG output from the light modulation element 182 into circularly polarized image light IG and outputs the circularly polarized image light IG toward the +D2 side along the D2 direction. The predetermined polarized light is, for example, P polarized light.

The light-exiting-side polarizer 176 is, for example, a reflective or absorptive polarizer plate having plate surfaces parallel to a plane containing the D1 and D3 directions. The light-exiting-side polarizer 176 transmits part of the incident image light IG that is image light IG containing the predetermined polarized light toward the +D2 side, and reflects or absorbs the other part of the image light IG toward the −D2 side. Note that when it is desired to suppress generation of return light and stray light directed to the light modulation element 182, it is desirable to employ an absorptive polarizer plate as the light-exiting-side polarizer 176.

The blue light output portion 103 is disposed at a position shifted toward the +D1 side from the green light output portion 102 in a region where the blue light output portion 103 overlaps with the red light output portion 101 in the D2 and D3 directions. The blue light output portion 103 outputs the blue light LB. The blue light LB output from the blue light output portion 103 travels toward the −D1 side along the D1 direction.

The blue light output portion 103 includes a light source 123, a light guide 143, and a parallelizing element 163. The light source 123 includes a substrate 113 and a light emitter 423. The light emitter 423 is provided at the −D1-side plate surface of the substrate 113 out of the plate surfaces thereof parallel to a plane containing the D2 and D3 directions. The light emission surface of the light emitter 423 is a surface located substantially in parallel to a plane containing the D2 and D3 directions, and being opposite, in the D1 direction, the surface of the light emitter 423 that is in contact with the −D1-side plate surface of the substrate 113.

The light source 123 corresponds to a second light source, and outputs the blue light LB having the blue wavelength band in the visible wavelength band. Unlike the red wavelength band and the green wavelength band, the blue wavelength band is, for example, a wavelength band ranging from 430 nm to 500 nm, and includes, for example, 467 nm.

The light emitter 423 corresponds to a second light emitter and is configured, for example, with an LED that emits the blue light LB. The LED that emits the blue light LB contains, for example, a gallium-nitride-based (GaN) semiconductor material having excellent light extraction efficiency as a light emitter. Note that the light emitter 423 may be configured with one LED or multiple LEDs in their entirety. When the light emitter 423 is configured with multiple LEDs, the multiple LEDs are arranged in the region occupied by the light emitter 423 in a plane containing the D2 and D3 directions.

Using an LED as the light source 123 suppresses the cost of the light source 123, and reduces speckle noise produced by the blue light contained in image light IM to be projected onto the screen SCR.

The substrate 113 is made, for example, of metal, and also serves as a heat dissipation member that receives heat from the light emitter 423, which emits the blue light LB, and dissipates the heat to an external space.

The light guide 143 is provided in the optical path of the blue light LB output from the light source 123, and is disposed on the −D1 side of the light source 123 at a position where the light guide 143 overlaps with the light source 123 in the D2 and D3 directions. The light guide 143 corresponds to a second light guide, and has a light incident end 143a facing the +D1 side in the D1 direction, a light exiting end 143b facing the −D1 side in the D1 direction, and side surfaces 143s and reflection surfaces 143r extending between the light incident end 143a and the light exiting end 143b in the D1 direction.

The light incident end 143a corresponds to a second light incident end and spreads in parallel to a plane containing the D2 and D3 directions. The shape of the light incident end 143a viewed in the D1 direction is the same as the shape of the light emission surface of the light source 123 viewed in the same direction, and is, for example, a quadrangular shape, specifically, a rectangular shape. The sizes of the light emission surface of the light source 123 in the D2 and D3 directions are each, for example, greater than or equal to 0.25 mm but smaller than or equal to 10 mm. The area of the light emission surface of the light source 123 viewed along the D1 direction ranges, for example, from 0.25 mm² to 10×10 mm².

The sizes of the light incident end 143a in a plane containing the D2 and D3 directions may be equal to the size of the light emission surface of the light source 123 in a plane containing the D2 and D3 directions, and is preferably appropriately greater than the size of the light emission surface of the light source 123 in the plane containing the D2 and D3 directions. A dimension of the opening through which the blue light LB enters the light guide 143 at the light incident end 143a that is the dimension along the major sides of the opening that are parallel to the D2 direction is greater than or equal to 1 mm but smaller than or equal to 3 mm, for example, about 2 mm.

The light exiting end 143b corresponds to a second light exiting end, spreads in parallel to a plane containing the D2 and D3 directions, and is larger than the light incident end 143a. The shape of the light exiting end 143b viewed in the D1 direction is the same as the shape of the light modulation surface of a light modulation element 183 viewed in the same direction, and is, for example, a quadrangular shape. The sizes of the light exiting end 143b in a plane containing the D2 and D3 directions are equal to the sizes of the light modulation surface of the light modulation element 183 in a plane containing the D2 and D3 directions.

A dimension of the opening through which the blue light LB exits out of the light guide 143 at the light exiting end 143b that is the dimension along the major sides of the opening that are parallel to the D2 direction is greater than or equal to 14 mm but smaller than or equal to 16 mm, for example, about 15 mm. The size of the light modulation surface of the light modulation element 183 in the major side direction, that is, the D2 direction is, for example, 15 mm. Note that the size of the light modulation surface of the light modulation element 183 may be selected as appropriate, for example, from values within the range from 6.48 mm×11.52 mm, which are the sizes of a 0.52-inch element, to 19.44 mm×34.56 mm, which are the sizes of a 1.5-inch element.

The side surfaces 143s and the reflection surfaces 143r couple the circumferential edge of the light incident end 143a to the circumferential edge of the light exiting end 143b in the D1 direction.

The blue light LB output from the light source 123 enters the light guide 143 via the light incident end 143a. In the light guide 143, the internal space surrounded by the light incident end 143a, the light exiting end 143b, and the reflection surfaces 143r is a region in which the blue light LB propagates. A size of the internal space surrounded by the light incident end 143a, the light exiting end 143b, and the reflection surfaces 143r that is the size in a plane containing the D2 and D3 directions increases as the internal space extends from the +D1 side toward the −D1 side in the D1 direction.

The cross-sectional area of the light exiting end 143b of the light guide 143 that contains the D2 and D3 directions, that is, the area occupied by the cross section of the light exiting end 143b that is parallel to a plane perpendicular to the center axis of the light guide 143 that is parallel to the D1 direction is greater than the cross-sectional area of the light incident end 143a of the light guide 143 that contains the same directions, that is, the area occupied by the cross section of the light incident end 143a of the light guide 143 that is parallel to the plane perpendicular to the center axis of the light guide 143. The area occupied by the cross section perpendicular to the center axis of the light guide 143 increases as the light guide 143 extends from the light incident end 143a toward the light exiting end 143b.

The shape of the internal space of the light guide 143 in a plane containing the D2 and D3 directions changes from the shape of the light emission surface of the light source 123 viewed in the D1 direction to the shape of the light modulation surface of the light modulation element 183 as the internal space extends from the +D1 side toward the −D1 side.

The side surfaces 143s of the light guide 143 and the reflection surfaces 143r provided at the side surfaces 143s as will be described later incline by a predetermined angle with respect to an imaginary line perpendicular to the light incident end 143a and the center axis of the light guide 143, and are separated away from the imaginary line in a plane containing the D2 and D3 directions as the light guide 143 extends from the +D1 side toward the −D1 side. The blue light LB having entered the light guide 143 propagates from the +D1 side toward the −D1 side in the internal space surrounded by the light incident end 143a, the light exiting end 143b, and the reflection surfaces 143r.

The light modulation surface of the light modulation element 183 viewed along the D1 direction has a quadrangular and rectangular shape, and the light emission surface of the light source 123 viewed along the D1 direction has a rectangular shape. A predetermined angle, that is, taper angle by which the side surfaces 143s and the reflection surfaces 143r containing the minor sides of the rectangular shape that are parallel to the D3 direction incline with respect to the imaginary line described above and the center axis of the light guide 143 is, for example, greater than or equal to 7° but smaller than or equal to 22°. A predetermined angle, that is, a taper angle of the side surfaces 143s and the reflection surfaces 143r containing the major sides of the rectangular shape that are parallel to the D2 direction with respect to the imaginary line described above and the center axis of the light guide 143 is greater than or equal to 14° but smaller than or equal to 36°. A preferable range of the taper angle is so set as appropriate that reflection films 253 of the light guide 143 have desired spectral reflectance derived by a numerical simulation based on the configuration of the blue light output portion 103 and ray tracing, as will be described later.

Part of the blue light LB having entered the light guide 143 inclines by angles smaller than the predetermined taper angle with respect to the imaginary line and the center axis of the light guide 143, and propagates directly from the light incident end 143a to the light exiting end 143b without being incident even once on the reflection surfaces 143r. The remainder of the blue light LB having entered the light guide 143 inclines by angles greater than or equal to the predetermined taper angle with respect to the imaginary line and the center axis of the light guide 143, is incident on the reflection surfaces 143r via the light incident end 143a once or a greater number of times, is reflected off the reflection surfaces 143r, and then reaches the light exiting end 143b. The paths of the beams constituting the blue light LB in the internal space of the light guide 143 vary in accordance with the angles of incidence of the beams incident on the light incident end 143a, and there are multiple paths along which the beams are reflected off the reflection surfaces 143r by different numbers of times.

The illuminance distribution of the blue light LB propagating in the internal space of the light guide 143 is homogenized in planes containing the D2 and D3 directions. That is, the light guide 143 homogenizes the illuminance distribution of the incident blue light LB in the planes containing the D2 and D3 directions. The blue light LB having the homogenized illuminance distribution exits via the light exiting end 143b toward the −D1 side.

The light guide 143 is a hollow reflector configured, for example, with plate-shaped members, as the light guides 141 and 142. The light guide 143 is formed, for example, in a quadrangular shape when viewed along the D1 direction, and is tapered from the light exiting end 143b toward the light incident end 143a. When viewed along the D1 direction, the +D1-side end of the light guide 143 has the same shape and size as the light incident end 143a and the light emission surface of the light source 123, and is formed, for example, in the shape of a quadrangular shape. The −D1-side end of the light guide 143 has the same shape and size as the light exiting end 143b and the light modulation surface of the light modulation element 183, and is formed, for example, in a quadrangular shape having a size different from that of the +D1-side end of the light guide 143.

The reflector of the light guide 143 is configured with four plate-shaped members and the reflection films 253. The light guide 143 is configured with four plate-shaped members each having a trapezoidal shape with the sides corresponding to the legs of the trapezoidal shape coupled to each other. The width, that is, the dimension of each of the sides facing the +D1 side that are parallel to the D2 or D3 direction and correspond to the upper bases of the four plate-shaped members is set in accordance with the size of the light incident end 143a and the light emission surface of the light source 123 in the D2 or D3 direction. The width, that is, the dimension of each of the sides facing the −D1 side that are parallel to the D2 or D3 direction and correspond to the lower bases of the four plate-shaped members is set in accordance with the size of the light exiting end 143b and the light modulation surface of the light modulation element 183 in the D2 or D3 direction.

In consideration of the size and the like of the light source 123, the width, that is, the dimension of each of the +D1-side end sides of the plate-shaped members of the light guide 143 that are parallel to the D2 direction is greater than or equal to 1 mm but smaller than or equal to 3 mm, for example, about 2 mm. The width, that is, the dimension of each of the −D1-side end sides of the plate-shaped members of the light guide 143 that are parallel to the D2 direction is greater than or equal to 14 mm but smaller than or equal to 16 mm, for example, about 15 mm. The length of each of the plate-shaped members of the light guide 143 from the light incident end 143a to the light exiting end 143b in the D1 direction is, for example, greater than or equal to 5 mm but shorter than or equal to 25 mm. The light guide 143 has the same shape as the light guides 141 and 142.

The material of the four plate-shaped members of the light guide 143 contains at least any of Al, Ag, and glass, that is, SiO₂, and is, for example, the same as the material of the plate-shaped members of the light guides 141 and 142.

To increase the reflectance in the vicinity of the side surface 143s for the blue light LB having entered the light guide 143 via the light incident end 143a, the reflector, that is, the light guide 143 is provided with the reflection films 253 each configured with a dielectric multilayer film or the like at plate surfaces opposite the side surfaces 143s of the plate-shaped members constituting the reflector, that is, the plate surfaces facing the internal space of the light guide 143. Part of the blue light LB having entered the internal space of the light guide 143 via the light incident end 143a is reflected off the reflection films 253 and travels toward the −D1 side.

The intensity of the blue light LB reflected off the reflection films 253 and output from the reflection films 253 depends in some cases on the angle of incidence of the blue light LB incident on the reflection films 253. When the reflection films 253 are each configured with a dielectric multilayer film, the dependence of the intensity of the blue light LB output from the reflection films 253 on the angle of incidence of the blue light LB changes in accordance, for example, with the numbers of the low refractive index layers and the high refractive index layers constituting the dielectric multilayer film, the refractive index of the low refractive index layers, the refractive index of the high refractive index layers, the difference in the refractive index between the low refractive index layers and the high refractive index layers, and other parameters. When the reflection films 253 are each configured with a metal film, the dependence of the intensity of the blue light LB output from the reflection films 253 on the angle of incidence of the blue light LB changes in accordance, for example, with the density of metal particles and other parameters.

The visibility of an image projected by the projector 350 is enhanced by setting the wavelength at which the spectral reflectance of the reflection films 253 is maximized to a wavelength at which the human visibility is maximized. Adjusting the parameters of the dielectric multilayer film or the metal film constituting each of the reflection films 253 allows effective control of the wavelength at which the reflectance of the reflection films 253 is maximized.

As described above, when the taper angle of the light guide 143 is greater than or equal to 7° but smaller than or equal to 22° or greater than or equal to 14° but smaller than or equal to 36°, the reflection films 253 are so designed that the angle of incidence of the blue light LB at which the intensity of the blue light LB output from the reflection surfaces 143r and the reflection films 253 is maximized falls within a predetermined angular range, and parameters of the dielectric multilayer film are determined as appropriate. The predetermined angular range ranges, for example, from 60° to 90°. The relationship between the angle of incidence of the blue light LB to be incident on the reflection films 253 and the intensity of the blue light LB output from the reflection films 253 is also derived by the numerical simulation based on the configuration of the blue light output portion 103 and the ray tracing.

The parallelizing element 163 is provided in the optical path of the blue light LB output from the light guide 143, and is disposed at a position which is shifted toward the −D1 side from the light guide 143 and where the parallelizing element 163 overlaps with the light guide 143 in the D2 and D3 directions. The parallelizing element 163 parallelizes the blue light LB output from the light guide 143 along the D1 direction. The parallelizing element 163 corresponds to a second parallelizing element.

The parallelizing element 163 is, for example, a planoconvex lens, and has a light incident surface configured with a planar surface perpendicular to the D1 direction, and a light exiting surface configured with a convex curved surface protruding toward the side via which the red light LR exits. The focal point of the planoconvex lens constituting the parallelizing element 163 is disposed at least on the +D1 side of the parallelizing element 163, and on the side opposite the −D1 side, where the blue light LB is output from the parallelizing element 163, and further on the +D1 side of the light guide 143.

The light incident surface of the parallelizing element 163 is in contact with the light exiting end 143b of the light guide 143. Since the parallelizing element 163 is in contact with the light exiting end 143b, the blue light LB output via the light exiting end 143b of the light guide 143 taken into the parallelizing element 163 is maximized, so that loss of the blue light LB can be suppressed. Note, however, that the parallelizing element 163 may be an optical lens different from a planoconvex lens but capable of parallelizing the incident blue light LB, and may be disposed at an appropriate distance from the light guide 143 in the D1 direction.

The light modulator 483 includes a light-incident-side polarizer 173, the light modulation element 183, and a light-exiting-side polarizer 177. The light modulator 483 corresponds to a second light modulator and modulates the incident blue light LB based on image information transmitted from the image formation apparatus such as a computer that is not shown but is disposed outside the projector 350.

The light-incident-side polarizer 173 is provided in the optical path of the blue light LB output from the parallelizing element 163, and is disposed at a position which is shifted toward the −D1 side from the parallelizing element 163 and where the light-incident-side polarizer 173 overlaps with the parallelizing element 163 in the D2 and D3 directions. The light-incident-side polarizer 173 is disposed, for example, at an appropriate distance from the light modulation element 183 in the D1 direction, and may instead be in contact with the +D1 side of the light modulation element 183.

The light-incident-side polarizer 173 outputs predetermined polarized light out of the blue light LB output from the parallelizing element 163 toward the −D1 side along the D1 direction. The predetermined polarized light is, for example, S polarized light. The light-incident-side polarizer 173 is, for example, a reflective polarizer plate having plate surfaces parallel to a plane containing the D2 and D3 directions. The light-incident-side polarizer 173 transmits part of the incident blue light LB that is blue light LB containing the predetermined polarized light toward the −D1 side, and reflects the other part of the blue light LB toward the +D1 side.

The blue light LB output from the light source 123 contains at least P polarized light and S polarized light and is, for example, randomly polarized light. The S-polarized component of the blue light LB output from the light source 123 sequentially passes through the light guide 143 and the parallelizing element 163 as described above, passes through the light-incident-side polarizer 173, and exits out of the light-incident-side polarizer 173 toward the −D1 side. The P-polarization component of the blue light LB sequentially passes through the light guide 143 and the parallelizing element 163 as the S-polarized component, but is reflected off the light incident surface of the light-incident-side polarizer 173 and exits out of the light-incident-side polarizer 173 toward the +D1 side.

The light modulation element 183 is provided in the optical path of the blue light LB output from the light-incident-side polarizer 173, and is disposed at a position which is shifted toward the −D1 side from the light-incident-side polarizer 173 and where the light modulation element 183 overlaps with the light-incident-side polarizer 173 in the D2 and D3 directions. The light modulation element 183 modulates the blue light LB output from the light-incident-side polarizer 173 based on image information transmitted from the image formation apparatus that is not shown but is externally coupled to the light modulation element 183.

The light modulation element 183 is, for example, a transmissive liquid crystal panel. The liquid crystal panel constituting the light modulation element 183 includes multiple pixels that are not shown. The pixels each include a switching element. The switching element is, for example, a TFT. The switching element in each of the pixels receives an electric signal according to the brightness of the blue light at a relative position in an image projected by the projector 350 with respect to the pixel at the light modulation surface of the light modulation element 183. The pixels each modulate the vibration direction of the blue light LB incident from the light-incident-side polarizer 173 with the aid of the operation of the switching element according to the electric signal described above to generate blue image light IB. The image light IB corresponds to the second light. The light modulation element 183 outputs the image light IB generated by the liquid crystal panel toward the −D1 side along the D1 direction.

The light-exiting-side polarizer 177 is provided in the optical path of the image light IB output from the light modulation element 183, and is disposed at a position which is shifted toward the −D1 side from the light modulation element 183 and where the light-exiting-side polarizer 177 overlaps with the light modulation element 183 in the D2 and D3 directions.

A portion of the light-exiting-side polarizer 177 is disposed, for example, at an appropriate distance from the light modulation element 183 and the light combiner 200 in the D1 direction. The remainder of the light-exiting-side polarizer 177 is in contact, for example, with the light incident surface of the light combiner 200, which is the surface on which the image light IB is incident, that is, a light incident surface 210e of the cross dichroic prism 210, which will be described later, from the +D1 side. Note that FIG. 1 does not show the portion of the light-exiting-side polarizer 177 but shows only the remainder of the light-exiting-side polarizer 177.

The light-exiting-side polarizer 177 outputs predetermined polarized light out of the image light IB output from the light modulation element 183 toward the −D1 side along the D1 direction. The predetermined polarized light is, for example, S polarized light.

The light-exiting-side polarizer 177 is, for example, a reflective or absorptive polarizer plate having plate surfaces parallel to a plane containing the D2 and D3 directions. The light-exiting-side polarizer 177 transmits part of the incident image light IB that is image light IB containing the predetermined polarized light toward the +D2 side, and reflects or absorbs the other part of the image light IB toward the −D2 side. Note that when it is desired to suppress generation of return light and stray light directed to the light modulation element 183, it is desirable that the light-exiting-side polarizer 177 is an absorptive polarizer plate.

The light combiner 200 is disposed in a region where the optical path of the red image light IR output from the light-exiting-side polarizer 175, the optical path of the green image light IG output from the light-exiting-side polarizer 176, and the optical path of the blue image light IB output from the light-exiting-side polarizer 177 intersect with one another. The light combiner 200 combines the image light IR, the image light IG, and the image light IB output from the light-exiting-side polarizers 175, 176, and 177 with one another, and outputs the combined image light toward the +D2 side along the D2 direction.

The light combiner 200 is, for example, what is called a non-polarizing cross dichroic prism 210 having no polarization dependence. The cross dichroic prism 210 has the light incident surface 210c facing the light exiting surface of the light-exiting-side polarizer 175, the light incident surface 210d facing the light exiting surface of the light-exiting-side polarizer 176, the light incident surface 210e facing the light exiting surface of the light-exiting-side polarizer 177, a light exiting surface 210b, and two reflection films 211 and 212. The light incident surfaces 210c and 210e are parallel to a plane containing the D2 and D3 directions, and coincide with each other in the D2 and D3 directions. The light incident surface 210d and the light exiting surface 210b are parallel to a plane containing the D1 and D3 directions, and coincide with each other in the D1 and D3 directions.

The reflection film 211 is disposed so as to extend from the +D2 side toward the −D2 side as extending from the −D1 side toward the +D1 side when viewed along the D3 direction. The reflection film 212 is disposed so as to extend from the −D2 side toward the +D2 side as extending from the −D1 side toward the +D1 side when viewed along the D3 direction. The reflection films 211 and 212 coincide with the light incident surfaces 210c and 210e in the D2 direction and coincide with the light exiting surface 210b and the light incident surface 210d in the D3 direction.

The reflection film 211 reflects light that belongs to the blue wavelength band and transmits light that belongs to the green wavelength band and light that belongs to the red wavelength band. The reflection film 212 reflects light that belongs to the red wavelength band and transmits light that belongs to the blue wavelength band and light that belongs to the green wavelength band. The reflection films 211 and 212 are each configured, for example, with a dielectric multilayer film.

The cross dichroic prism 210 is so configured that, when viewed in the D3 direction, four rectangular prisms are glued to each other along the right angle forming surfaces with the right-angle vertices positioned at the center of the light combiner 200. The four rectangular prisms of the cross dichroic prism 210 are made of a transparent material that transmits light that belongs to the visible wavelength band.

The reflection film 211 is disposed at the side surfaces that extend from the +D2 side toward the −D2 side as extending from the −D1 side toward the +D1 side as described above out of the side surfaces constituting the right angles of the four rectangular prisms, that is, one intersecting surface, and is configured, for example, with a dielectric multilayer film. The reflection film 212 is disposed at the side surfaces that extend from the −D2 side toward the +D2 side as extending from the −D1 side toward the +D1 side as described above out of the side surfaces that constitute the right angles of the four rectangular prisms, that is, the other intersecting surface.

The S-polarized red image light IR output from the light-exiting-side polarizer 175 enters the interior of the cross dichroic prism 210 via the light incident surface 210c toward the +D1 side along the D1 direction, passes through the reflection film 211, is reflected off the reflection film 212, and travels toward the +D2 side. The P-polarized green image light IG output from the light-exiting-side polarizer 176 enters the interior of the cross dichroic prism 210 via the light incident surface 210d toward the +D2 side along the D2 direction, passes through the reflection films 211 and 212, and travels straight toward the +D2 side. The S-polarized blue image light IB output from the light-exiting-side polarizer 177 enters the interior of the cross dichroic prism 210 via the light incident surface 210e toward the −D1 side along the D1 direction, passes through the reflection film 212, is reflected off the reflection film 211, and travels toward the +D2 side.

The image light IB, the image light IG, and the image light IR output from the reflection films 211 and 212 of the cross dichroic prism 210 toward the +D2 side are combined with one another into the full-color image light IM. The cross dichroic prism 210 outputs the full-color image light IM via the light exiting surface 210b toward the +D2 side along the D2 direction. An antireflection film 220 is provided at the light exiting surface 210b. The antireflection film 220 prevents the image light IM output via the light exiting surface 210b of the cross dichroic prism 210 from being reflected toward the −D2 side, and outputs substantially all the image light IM output via the light exiting surface 210b toward the +D2 side.

The projection system 390 is disposed in the optical path of the image light IM output from the light combiner 200 of the optical module 310. The projection system 390 projects the image light IM output from the light combiner 200 onto the screen SCR disposed on the +D2 side, enlarges images transmitted from the image formation apparatus to the light modulation elements 181, 182, and 183, and displays the enlarged images on the screen SCR.

The projection system 390 is configured, for example, with one or more optical lenses arranged along the D2 direction. Examples of the optical lenses may include a planoconvex lens, a planoconcave lens, a biconvex lens, a biconcave lens, a meniscus lens, an aspherical lens, and a freeform surface lens.

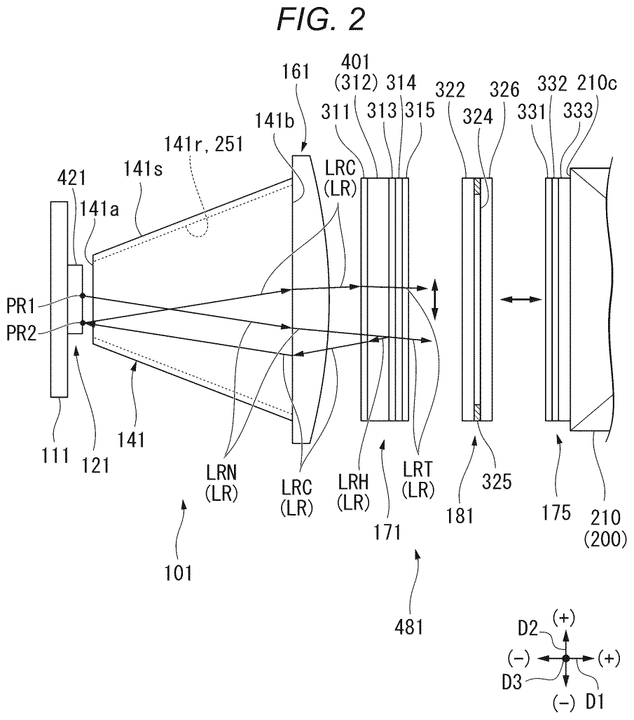

FIG. 2 is a schematic view of the red light output portion 101 and the light modulator 481 of the optical module 310 according to the present embodiment.

The light-incident-side polarizer 171 of the light modulator 481 includes an antireflection film 311, a retardation film 312, a reflective polarizing layer 313, an absorptive polarizing layer 314, and an antireflection film 315, as shown in FIG. 2. The antireflection film 311, the retardation film 312, the reflective polarizing layer 313, the absorptive polarizing layer 314, and the antireflection film 315 are sequentially disposed from the −D1 side toward the +D1 side and are integrated into a single unit.

The antireflection film 311 is provided at the light incident surface of the retardation film 312, which is the surface on which the red light LR is incident, and the antireflection film 311 is in contact with the −D1-side surface of the retardation film 312 out of the surfaces thereof parallel to a plane containing the D2 and D3 directions. The antireflection film 311 prevents the red light LR incident on the light-incident-side polarizer 171 from being reflected toward the −D1 side, outputs substantially all the incident red light LR toward the +D1 side, and causes the red light LR to enter the retardation film 312. The antireflection film 311 also outputs toward the −D1 side substantially all the red light LR incident from the +D1 side, and outputs the red light LR from the light-incident-side polarizer 171 toward the −D1 side, as will be described later.

The retardation film 312 corresponds to a first polarization converter, and changes the polarization state of the red light LR entering the light-incident-side polarizer 171 and output from the antireflection film 311. The retardation film 312 functions in the same manner as a λ/4 wave plate, changes the polarization state of the incident red light LR, and converts, for example, linearly polarized light into circularly polarized light or circularly polarized light into linearly polarized light.

The retardation film 312 is configured with a quartz crystal substrate 401. Since the retardation film 312 is the quartz crystal substrate 401, the heat dissipation capability of the retardation film 312 is enhanced, and the direction of the crystal axis and the polarization separation characteristic of the quartz crystal substrate 401 can be readily set in accordance with the thickness thereof in the D1 direction. The thickness of the quartz crystal substrate 401 in the D1 direction ranges, for example, from 0.250 mm to 0.650 mm. The polarization state of most of the red light LR incident on the quartz crystal substrate 401 can thus be changed. Note that the retardation film 312 is made of an anisotropic material having a crystal axis along a predetermined direction, and may be configured, for example, with a substrate made of a sapphire single crystal other than quartz crystal.

The reflective polarizing layer 313 is provided at the light exiting surface of the retardation film 312, which is the surface via which the red light LR exits, and is in contact with the +D1-side surface of the retardation film 312 out of the surfaces thereof parallel to a plane containing the D2 and D3 directions. The reflective polarizing layer 313 corresponds to a first polarization separator, transmits longitudinally polarized red light LRT out of the red light LR passing through the retardation film 312 and output from the retardation film 312, and reflects laterally polarized red light LRH out of the red light LR passing through the retardation film 312 and output from the retardation film 312.

The red light LRT passing through the reflective polarizing layer 313 corresponds to at least part of a first polarized component of the first light passing through the first polarization converter. The red light LRH reflected off the reflective polarizing layer 313 corresponds to the other part of the first polarized component of the first light passing through the first polarization converter. The longitudinally polarized red light LRT is, for example, S-polarized light. The laterally polarized red light LRH is, for example, P-polarized light.

The absorptive polarizing layer 314 is provided at the light exiting surface of the reflective polarizing layer 313 and is in contact with the +D1-side surface of the reflective polarizing layer 313 out of the surfaces thereof along a plane containing the D2 and D3 directions. The absorptive polarizing layer 314 transmits the red light LRT passing through the reflective polarizing layer 313 and output from the reflective polarizing layer 313, and absorbs the red light LRH that is not shown but passing through the retardation film 312 and output from the retardation film 312 by a small amount. Note that when the reflective polarizing layer 313 is a high-precision polarizing layer, and the amount of the red light LRH output from the reflective polarizing layer 313 toward the +D1 side is sufficiently small, the absorptive polarizing layer 314 may be omitted.

The antireflection film 315 is provided at the light exiting surface of the absorptive polarizing layer 314 and is in contact with the +D1-side surface of the absorptive polarizing layer 314 out of the surfaces thereof along a plane containing the D2 and D3 directions. The antireflection film 315 prevents the red light LRT output from the absorptive polarizing layer 314 and incident from the −D1 side from being reflected toward the −D1 side, and outputs substantially all the incident red light LRT toward the +D1 side.

The light modulation element 181 is configured with a transmissive liquid crystal panel as described above, and includes a counter substrate 322, a liquid crystal layer 324, a sealing member 325, and an element substrate 326. The counter substrate 322, the liquid crystal layer 324, the sealing member 325, and the element substrate 326 are integrated into a single unit.

The counter substrate 322 and the element substrate 326 are disposed so as to face each other in the D1 direction via the sealing member 325 having the shape of a frame. The liquid crystal layer 324 is disposed between the counter substrate 322 and the element substrate 326 in the D1 direction, and is surrounded by the sealing member 325 in a plane containing the D2 and D3 directions.

A counter electrode is provided at the +D1-side plate surface of the counter substrate 322, which is a surface parallel to a plane containing the D2 and D3 directions. Multiple pixel electrodes and switching elements corresponding to the multiple pixels are provided at the −D1-side plate surface of the element substrate 326, which is the surface parallel to a plane containing the D2 and D3 directions. The multiple pixel electrodes face the counter electrode via the liquid crystal layer 324 in the D1 direction.

The light-exiting-side polarizer 175 of the light modulator 481 includes an antireflection film 331, an absorptive polarizing layer 332, and a retardation film 333. The antireflection film 331, the absorptive polarizing layer 332, and the retardation film 333 are sequentially disposed from the −D1 side toward the +D1 side and are integrated into a single unit. The +D1-side plate surface of the retardation film 333, which is the surface parallel to a plane containing the D2 and D3 directions, is in contact with the light incident surface 210c of the cross dichroic prism 210 of the light combiner 200 from the −D1 side.

The antireflection film 331 prevents the red image light IR output from the light modulation element 181 from being reflected toward the −D1 side, and outputs substantially all the incident image light IR toward the +D1 side. The absorptive polarizing layer 332 is provided at the light exiting surface of the antireflection film 331 and is in contact with the +D1-side surface of the antireflection film 331, which is the surface parallel to a plane containing the D2 and D3 directions.

The absorptive polarizing layer 332 transmits the image light IR passing through the antireflection film 331, output from the antireflection film 331, and polarized in a predetermined polarization direction, and absorbs the image light IR passing through the antireflection film 331, output from the antireflection film 331 by a small amount, and polarized in the polarization directions other than the predetermined polarization direction. Note that when the amount of the image light IR output from the antireflection film 331 toward the +D1 side and polarized in the polarization directions other than the predetermined polarization direction is sufficiently small, the absorptive polarizing layer 332 may be omitted.

The retardation film 333 changes the polarization state of the image light IR output from the absorptive polarizing layer 332. The retardation film 333 functions in the same manner as a λ/4 wave plate, changes the polarization state of the incident image light IR, and converts, for example, linearly polarized light into circularly polarized light. The retardation film 333 is configured, for example, with a quartz crystal substrate.

FIG. 2 shows an example of the chief ray of the red light LR that enters the light guide 141 via the light incident end 141a and propagates directly to the light exiting end 141b without being incident on the reflection surfaces 141r even once out of the red light LR emitted from the light emitter 421 of the light source 121.

The red light LR output toward the +D1 side from a position PR1 on the light emission surface of the light emitter 421 is non-polarized red light LRN, contains S-polarized light and P-polarized light, enters the light guide 141 via the light incident end 141a, is guided by the light guide 141 toward the +D1 side, and exits via the light exiting end 141b. The red light LRN output from the light guide 141 is parallelized along the D1 direction by the parallelizing element 161, enters the light-incident-side polarizer 171, and passes through the antireflection film 311 of the light-incident-side polarizer 171.

The red light LRN passing through the antireflection film 311 enters the retardation film 312 from the −D1 side and passes through the retardation film 312 from the −D1 side toward the +D1 side. The polarization state of the red light LRN changes while the red light LRN passes through the retardation film 312, and, for example, the ratio between the S-polarized light and the P-polarized light contained in the red light LRN changes. Note that the polarization conversion performed by the retardation film 312 is performed on the red light LR caused by the reflective polarizing layer 313 to return to the retardation film 312. The longitudinally polarized red light LRT out of the red light LRN output from the retardation film 312 and entering the reflective polarizing layer 313 sequentially passes through the reflective polarizing layer 313, the absorptive polarizing layer 314, and the antireflection film 315, and exits out of the light-incident-side polarizer 171 toward the +D1 side.

The laterally polarized red light LRH out of the red light LRN output from the retardation film 312 and incident on the reflective polarizing layer 313 is reflected off the reflective polarizing layer 313, enters the retardation film 312 again from the +D1 side, and is converted into circularly polarized red light LRC when passing through the retardation film 312. The red light LRC contains S-polarized light and P-polarized light at a ratio of about 1:1. The red light LRC output from the retardation film 312 toward the −D1 side passes through the antireflection film 311 and exits out of the light-incident-side polarizer 171 toward the −D1 side.

The red light LRC output from the light-incident-side polarizer 171 toward the −D1 passes through the parallelizing element 161, enters the light guide 141 via the light exiting end 141b, is guided by the light guide 141 toward the −D1 side, and exits via the light incident end 141a. At least part of the red light LRC output from the light guide 141 toward the −D1 side is reflected at a position PR2, which differs from the position PR1, on the light emission surface of the light emitter 421 of the light source 121, toward the +D1 side. When reflected off the light emission surface of the light emitter 421, the polarization state of the red light LRC does not change but remains circularly polarized.

The red light LRC reflected off the light emission surface of the light emitter 421 of the light source 121 toward the +D1 side enters the light guide 141 via the light incident end 141a, is guided by the light guide 141 toward the +D1 side, and exits via the light exiting end 141b. The red light LRC output from the light guide 141 is parallelized along the D1 direction by the parallelizing element 161, enters the light-incident-side polarizer 171, and passes through the antireflection film 311 of the light-incident-side polarizer 171.

The red light LRC passing through the antireflection film 311 enters the retardation film 312 from the −D1 side, and passes through the retardation film 312 from the −D1 side toward the +D1 side. The polarization state of the red light LRC changes while the red light LRC passes through the retardation film 312, and the red light LRC is converted into the longitudinally polarized red light LRT. The red light LRT output from the retardation film 312 and entering the reflective polarizing layer 313 sequentially passes through the reflective polarizing layer 313, the absorptive polarizing layer 314, and the antireflection film 315, and exits out of the light-incident-side polarizer 171 toward the +D1 side. The vibration direction of the red light LRT output from the light-incident-side polarizer 171 toward the +D1 side is, for example, parallel to the D2 direction.

The red light LRT output from the light-incident-side polarizer 171 toward the +D1 side is converted into the image light IR by the light modulation element 181. The vibration direction of the image light IR output from the light modulation element 181 toward the +D1 side is, for example, parallel to the D1 direction. As described above, the vibration direction of the image light IR output from the light-exiting-side polarizer 175 toward the +D1 side includes, for example, multiple directions.

The image light IR output from the light modulation element 181, entering the light-exiting-side polarizer 175 from the −D1 side, and polarized in the predetermined polarization direction passes through the antireflection film 331 and the absorptive polarizing layer 332, and enters the retardation film 333. The image light IR polarized in the predetermined polarization direction and entering the retardation film 333 from the −D1 side is converted into circularly polarized light. The image light IR output from the light-exiting-side polarizer 175 toward the +D1 side enters the cross dichroic prism 210 of the light combiner 200 via the light incident surface 210c, as described above.

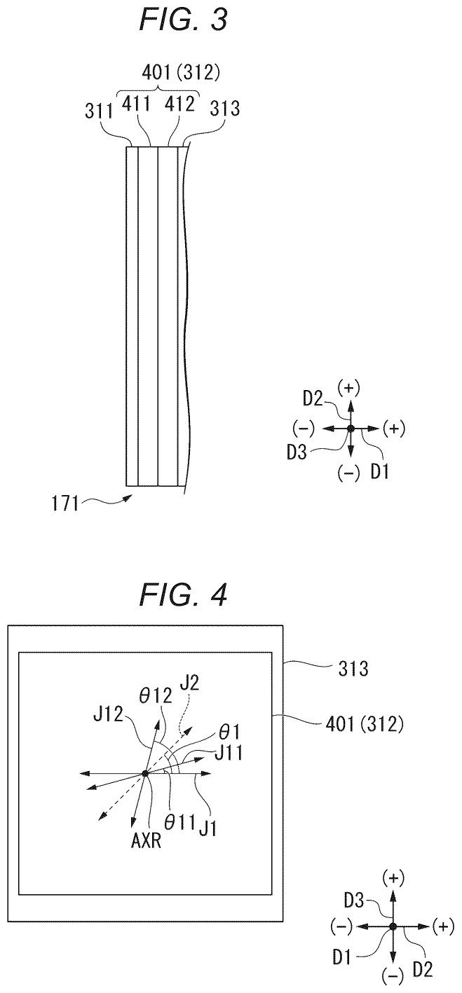

FIG. 3 is a schematic view of the retardation film 312 of the light-incident-side polarizer 171 of the light modulator 481. The quartz crystal substrate 401, which constitutes the retardation film 312, includes, for example, a first quartz crystal substrate 411 and a second quartz crystal substrate 412, as shown in FIG. 3. The first quartz crystal substrate 411 is disposed on the −D1 side in the quartz crystal substrate 401. The thickness of the first quartz crystal substrate 411 in the D1 direction ranges, for example, from 0.300 mm to 0.400 mm.

The second quartz crystal substrate 412 is provided at the +D1-side plate surface of the first quartz crystal substrate 411, which is the surface parallel to a plane containing the D2 and D3 directions, is in contact with the first quartz crystal substrate 411 in the D1 direction, and is integrated with the first quartz crystal substrate 411. The thickness of the second quartz crystal substrate 412 in the D1 direction ranges, for example, from 0.100 mm to 0.200 mm. The thickness of the first quartz crystal substrate 411 in the D1 direction and the thickness of the second quartz crystal substrate 412 in the D1 direction are, however, not limited to the values described above. For example, the thickness of the first quartz crystal substrate 411 in the D1 direction can range from 0.200 mm to 0.400 mm, and the thickness of the second quartz crystal substrate 412 in the D1 direction can range from 0.200 mm to 0.400 mm.

FIG. 4 is a schematic view of the retardation film 312 and the reflective polarizing layer 313 viewed from the −D1 side along the D1 direction. In FIG. 4, the reflective polarizing layer 313 is shown to be larger than the retardation film 312 when viewed along the D1 direction to clearly show the positional relationship between the retardation film 312 and the reflective polarizing layer 313.

The first quartz crystal substrate 411 has a first crystal axis J11. A transmission axis J1 of the reflective polarizing layer 313 is, for example, parallel to the D2 direction. The first crystal axis J11 inclines with respect to the D2 and D3 directions when viewed along the D1 direction, and inclines by a predetermined angle θ11 with respect to the transmission axis J1 of the reflective polarizing layer 313. The angle θ11 is, for example, 15°. Since the thickness of the first quartz crystal substrate 411 is set at a value ranging from 0.3 mm to 0.4 mm as described above, the angle by which the first crystal axis J11 inclines with respect to the transmission axis J1 is readily set at a predetermined angle such as 15°.

The second quartz crystal substrate 412 has a second crystal axis J12. The second crystal axis J12 inclines with respect to the D2 and D3 directions when viewed along the D1 direction, and inclines by a predetermined angle θ12 with respect to the transmission axis J1 of the reflective polarizing layer 313. The angle θ12 is, for example, 75°. Since the thickness of the second quartz crystal substrate 412 is set at a value ranging from 0.1 mm to 0.2 mm as described above, the angle by which the second crystal axis J12 inclines with respect to the transmission axis J1 is readily set at a predetermined angle such as 75°. The angle by which the first crystal axis J11 inclines with respect to the transmission axis J1, and the angle by which the second crystal axis J12 inclines with respect to the transmission axis J1 are, however, not limited to those described above. For example, when the thickness of the first quartz crystal substrate 411 in the D1 direction ranges from 0.300 mm to 0.400 mm, and the thickness of the second quartz crystal substrate 412 in the D1 direction ranges from 0.300 mm to 0.400 mm, the angle by which the first crystal axis J11 inclines with respect to the transmission axis J1 can be 45°, and the angle by which the second crystal axis J12 inclines with respect to the transmission axis J1 can be 135°.

The combination of the angle by which the first crystal axis J11 inclines with respect to the transmission axis J1 and the angle by which the second crystal axis J12 inclines with respect to the transmission axis J1 causes a crystal axis J2 of the quartz crystal substrate 401 to incline by an angle of about 45° with respect to the transmission axis J1 of the reflective polarizing layer 313. An angle θ1 by which the crystal axis J2 inclines with respect to the transmission axis J1 is preferably 45°, and is so set as appropriate that the polarization states of the red light LRN and LRC entering the quartz crystal substrate 401 favorably change, and that the ratio between the longitudinally polarized light and the laterally polarized light contained in the red light LR output from the quartz crystal substrate 401, which is the retardation film 312, to the reflective polarizing layer 313 is a predetermined ratio such as 1:1.

The angle by which each of the first crystal axis J11, the second crystal axis J12, and the crystal axis of the quartz crystal substrate 401 inclines with respect to the transmission axis J1 of the reflective polarizing layer 313 is a narrow angle by which the crystal axis inclines counterclockwise with respect to an imaginary line that is not shown but overlaps with the transmission axis J1 and extends toward the +D2 side from an optical axis AXR of the red light LR entering the reflective polarizing layer 313 of the light-incident-side polarizer 171 when viewed along the D1 direction from the −D1 side.

The angles θ11 and 012 are set as appropriate in accordance with the angle θ1 in consideration of the spectrum of the red light LR output from the light source 121 and entering the retardation film 312 of the light-incident-side polarizer 171 of the light modulator 481. The thickness of the first quartz crystal substrate 411 is set as appropriate in accordance with the angle θ11. The thickness of the second quartz crystal substrate 412 is set as appropriate in accordance with the angle θ12.

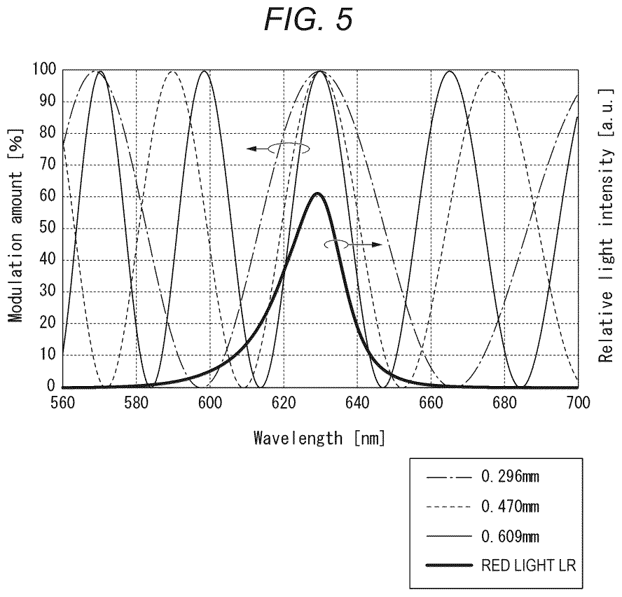

FIG. 5 shows graphs illustrating an example of results of numerical calculation of the dependence of the amount of phase modulation on the thickness of the quartz crystal substrate 401, the results showing how the amount of modulation of the phase of the red light LR made by the single-plate quartz crystal substrate 401, which constitutes the retardation film 312, changes with respect to the thickness of the quartz crystal substrate 401 in the D1 direction, and the spectrum of the red light LR entering the quartz crystal substrate 401. In the present numerical calculation, the thickness of the quartz crystal substrate 401 in the D1 direction was changed among 0.296 mm, 0.470 mm, and 0.609 mm.

In FIG. 5, the amount of phase modulation made by the quartz crystal substrate 401 is expressed in the form of a relative value on the assumption that the amount of phase modulation is 100% when a phase difference of λ/4, that is, a phase difference of π/2 is added to the phase of the red light LR entering the quartz crystal substrate 401. As for the spectrum of the red light LR entering the quartz crystal substrate 401 in FIG. 5, to show the relative relationship with the amount of phase modulation made by the quartz crystal substrate 401 in an easy-to-understand manner, FIG. 5 diagrammatically shows relative values of the light intensity of the red light LR versus the wavelengths on the horizontal axis that are common to the amount of phase modulation made by the quartz crystal substrate 401.

The red light LR entering the quartz crystal substrate 401 has a primary light emission peak in a red wavelength band ranging, for example, from 600 nm to 650 nm, as shown in FIG. 5. The peak wavelength of the red light LR is, for example, about 630 nm. The wavelength band that satisfies the half value of the spectrum of the red light LR ranges from about 618 nm to 638 nm.

When the thickness of the quartz crystal substrate 401 successively increases to 0.296 mm, 0.470 mm, and 0.609 mm, the peak wavelength of the profile of the amount of phase modulation made by the quartz crystal substrate 401 does not substantially change, and is about 630 nm close to the peak wavelength of the spectrum of the red light LR. However, when the thickness of the quartz crystal substrate 401 successively increases to 0.296 mm, 0.470 mm, and 0.609 mm, the wavelength band that satisfies the half value of the profile of the amount of phase modulation of the quartz crystal substrate 401 successively narrows.

When the thickness of the quartz crystal substrate 401 is 0.296 mm and 0.470 mm, substantially the entire wavelength band that satisfies the half value of the spectrum of the red light LR fall within the wavelength band that satisfies the half value of the profile of the amount of phase modulation of the quartz crystal substrate 401. Therefore, when it is assumed that the angle θ1 by which the crystal axis J2 of the quartz crystal substrate 401 inclines with respect to the transmission axis J1 of the reflective polarizing layer 313 is 45° as described above in consideration of the spectrum of the red light LR, and the thickness of the quartz crystal substrate 401 is 0.296 mm and 0.470 mm, the polarization state of substantially the entire amount of the red light LR entering the quartz crystal substrate 401 changes as intended, and the amount of the longitudinally polarized red light LR output from the reflective polarizing layer 313 is relatively large.

When the thickness of the quartz crystal substrate 401 is 0.609 mm, only a portion of the wavelength band that satisfies the half value of the spectrum of the red light LR falls within the wavelength band that satisfies the half value of the profile of the amount of phase modulation made by the quartz crystal substrate 401. Therefore, considering and assuming the same described above, when the thickness of the quartz crystal substrate 401 is 0.609 mm, the polarization state of only part of the red light LR entering the quartz crystal substrate 401 changes as intended, but the amount of the longitudinally polarized red light LR output from the reflective polarizing layer 313 is relatively small.

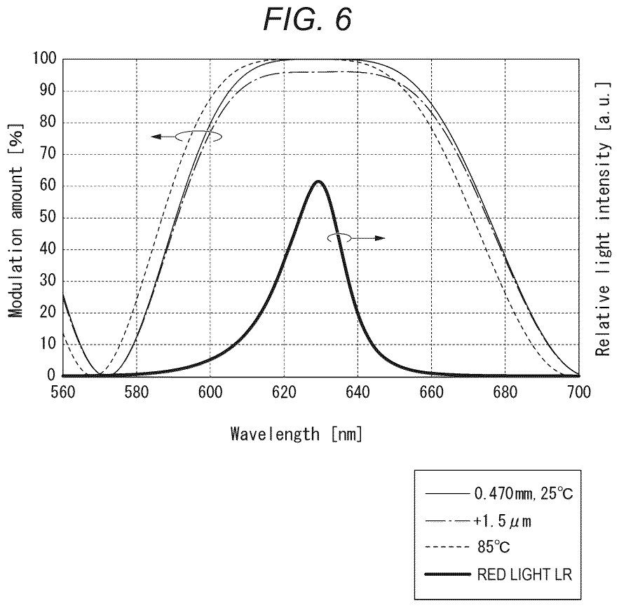

FIG. 6 shows graphs illustrating an example of results of numerical calculation of the amount of phase modulation made by the quartz crystal substrate 401 and the spectrum of the red light LR entering the quartz crystal substrate 401 in a case where the thickness of the first quartz crystal substrate 411 of the quartz crystal substrate 401 in the D1 direction is 0.313 mm, the thickness of the second quartz crystal substrate 412 of the quartz crystal substrate 401 in the D1 direction is 0.157 mm, so that the total thickness of the quartz crystal substrate 401 in the D1 direction is 0.470 mm, and the temperature inside an exterior body of the projector 350 is 25° C.

The present numerical calculation also shows, for reference, results of numerical calculation of the amount of phase modulation in a case where the thickness of the quartz crystal substrate 401 in the D1 direction increases by about +1.5 μm and the amount of phase modulation in a case where the thickness of the quartz crystal substrate 401 is 0.470 mm and the temperature inside the exterior body of the projector 350 is 85° C.

In the case where the thickness of the quartz crystal substrate 401 is 0.470 mm common to FIGS. 5 and 6, the half width of the profile of the amount of phase modulation made by the quartz crystal substrate 401 increases to about 83 nm achieved when the first quartz crystal substrate 411 and the second quartz crystal substrate 412 are bonded to each other, as compared to about 20 nm achieved when the quartz crystal substrate 401 is configured with a single plate, as shown in FIGS. 5 and 6.

When the thickness of the quartz crystal substrate 401 is 0.470 mm, and the quartz crystal substrate 401 is configured with a single plate, the polarization state of the primary red light LR having a wavelength band greater than or equal to at least the half value of the spectrum profile of the red light LR but smaller than or equal to the maximum value thereof can be changed by the quartz crystal substrate 401 of the retardation film 312, as described above. When the quartz crystal substrate 401 is configured with a single plate, the cost of the quartz crystal substrate 401 and hence the cost of the projector 350 can be suppressed.

When the thickness of the quartz crystal substrate 401 is 0.470 mm, and the quartz crystal substrate 401 is configured with a bonded-two-piece quartz crystal substrate as described above, the polarization state of the red light LR within the entire wavelength band greater than or equal to the minimum value of the light intensity of the red light LR, that is, greater than or equal to zero but smaller than or equal to the maximum value thereof can be changed by the quartz crystal substrate 401 of the retardation film 312, and the polarization conversion performance of the quartz crystal substrate 401 can be enhanced as compared to that in the case where the quartz crystal substrate 401 is configured with a single plate.

When the quartz crystal substrate 401 is configured with a bonded-two-piece quartz crystal substrate as described above, and even when the thickness of the quartz crystal substrate 401 increases by +1.5 μm or even when the temperature around the quartz crystal substrate 401 in the projector 350 changes from 25° C. to 85° C., the half width of the profile of the amount of phase modulation made by the quartz crystal substrate 401 does not substantially change, and the polarization state of the red light LR within the entire wavelength band greater than or equal to the minimum value of the light intensity of the red light LR but smaller than or equal to the maximum value thereof can be changed by the quartz crystal substrate 401, as shown in FIG. 6.

Whether the quartz crystal substrate 401 is configured with a single plate or configured with the first quartz crystal substrate 411 and the second quartz crystal substrate 412 bonded to each other can be determined based on the results of the numerical calculation of the dependence of the amount of phase modulation made by the quartz crystal substrate 401 on the wavelength of the light of interest in consideration of the configuration of the single substrate or the configurations of the two substrates, and the spectrum of the red light LR output from the light source 121 and entering the quartz crystal substrate 401, as in the example described above. Furthermore, the angle θ1 by which the crystal axis of the quartz crystal substrate 401 inclines with respect to the transmission axis of the reflective polarizing layer 313 and the thickness of the quartz crystal substrate 401 in the D1 direction can also be set as appropriate based on the results of the numerical calculation. Note that the retardation film 312 may include two or more quartz crystal substrates, and the two or more quartz crystal substrates may be layered on each other in the D1 direction.

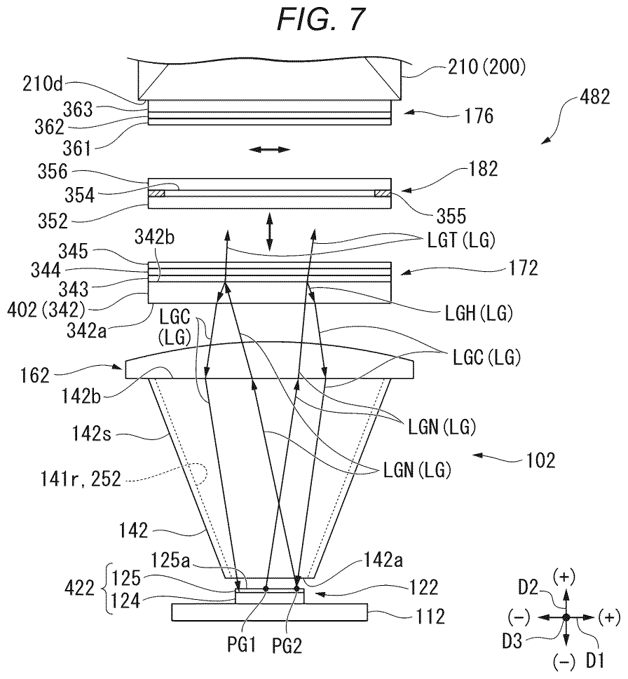

FIG. 7 is a schematic view of the green light output portion 102 and the light modulator 482 of the optical module 310 according to the present embodiment.

The light emitter 422 of the light source 122 includes, for example, an LED body 124 made of a semiconductor and a phosphor 125, as shown in FIG. 7. The LED body 124 contains, for example, a GaN-based semiconductor material having excellent light extraction efficiency, and emits blue light. The blue light emitted from the LED body 124 corresponds to fourth light. The type and material of the LED body 124 and the type and material of the phosphor 125 are appropriately so selected that the phosphor excited with the light emitted from the LED body 124 emits the green light LG having the green wavelength band.

The phosphor 125 is layered on the light exiting surface of the LED body 124, which is the surface facing the +D2 side. The phosphor 125 corresponds to a wavelength conversion element and is excited with the light emitted as excitation light from the LED body, and emits the green light LG in the form of fluorescence via the light exiting surface. When the LED body emits blue light as described above, the phosphor contains, for example, cerium-doped yttrium aluminum garnet (YAG: Ce³⁺), which is a light transmissive ceramic material.

The light-incident-side polarizer 172 of the light modulator 482 includes a retardation film 342, a reflective polarizing layer 343, an absorptive polarizing layer 344, and an antireflection film 345. The retardation film 342, the reflective polarizing layer 343, the absorptive polarizing layer 344, and the antireflection film 345 are sequentially disposed from the −D2 side toward the +D2 side and are integrated into a single unit.

The retardation film 342 serves as a polarization converter and changes the polarization state of the green light LG entering the light-incident-side polarizer 172. The retardation film 342 functions in the same manner as a λ/4 wave plate, changes the polarization state of the incident green light LG, and converts, for example, linearly polarized light into circularly polarized light or circularly polarized light into linearly polarized light.

The retardation film 342 is configured with a quartz crystal substrate 402. Since the retardation film 342 is the quartz crystal substrate 402, the heat dissipation capability of the retardation film 342 is enhanced, and the direction of the crystal axis and the polarization separation characteristic of the quartz crystal substrate 402 can be readily set in accordance with the thickness thereof in the D2 direction. Note that the retardation film 342 is made of an anisotropic material having a crystal axis along a predetermined direction, and may be configured, for example, with a substrate made of a sapphire single crystal other than quartz crystal.

The reflective polarizing layer 343 is provided at a light exiting surface 342b of the retardation film 342, which is the surface via which the green light LG exits, and is in contact with the +D2-side surface of the retardation film 342 out of the surfaces thereof parallel to a plane containing the D1 and D3 directions. The reflective polarizing layer 343 serves as a polarization separator, transmits longitudinally polarized green light LGT out of the green light LG passing through the retardation film 342 and output from the retardation film 342, and reflects laterally polarized green light LGH out of the green light LG passing through the retardation film 342 and output from the retardation film 342. The longitudinally polarized green light LGT is, for example, P-polarized light. The laterally polarized green light LGH is, for example, S-polarized light.

The absorptive polarizing layer 344 is provided at the light exiting surface of the reflective polarizing layer 343 and is in contact with the +D2-side surfaces of the reflective polarizing layer 343 out of the surfaces thereof along a plane containing the D1 and D3 directions. The absorptive polarizing layer 344 transmits the green light LGT passing through the reflective polarizing layer 343 and output from the reflective polarizing layer 343, and absorbs the green light LGH that is not shown but passing through the retardation film 342 and output from the retardation film 342 by a small amount. Note that when the reflective polarizing layer 343 is a high-precision polarizing layer, and the amount of the green light LGH output from the reflective polarizing layer 343 toward the +D2 side is sufficiently small, the absorptive polarizing layer 344 may be omitted.

The antireflection film 345 is provided at the light exiting surface of the absorptive polarizing layer 344 and is in contact with the +D2-side surface of the absorptive polarizing layer 344 out of the surfaces thereof along a plane containing the D1 and D3 directions. The antireflection film 345 prevents the green light LGT output from the absorptive polarizing layer 344 and incident from the −D2 side from being reflected toward the −D2 side, and outputs substantially all the incident green light LGT toward the +D2 side.

The light modulation element 182 is configured with a transmissive liquid crystal panel as described above, and includes a counter substrate 352, a liquid crystal layer 354, a sealing member 355, and an element substrate 356. The counter substrate 352, the liquid crystal layer 354, the sealing member 355, and the element substrate 356 are integrated into a single unit.

The counter substrate 352 and the element substrate 356 are disposed so as to face each other in the D2 direction via the sealing member 355 having the shape of a frame. The liquid crystal layer 354 is disposed between the counter substrate 352 and the element substrate 356 in the D2 direction, and is surrounded by the sealing member 355 in a plane containing the D1 and D3 directions.

A counter electrode is provided at the +D2-side plate surface of the counter substrate 352, which is a surface parallel to a plane containing the D1 and D3 directions. Multiple pixel electrodes and switching elements corresponding to the multiple pixels are provided at the −D2-side plate surface of the element substrate 356, which is the surface parallel to a plane containing the D1 and D3 directions. The multiple pixel electrodes face the counter electrode via the liquid crystal layer 354 in the D2 direction.

The light-exiting-side polarizer 176 of the light modulator 482 includes an antireflection film 361, an absorptive polarizing layer 362, and a retardation film 363. The antireflection film 361, the absorptive polarizing layer 362, and the retardation film 363 are sequentially disposed from the −D2 side toward the +D2 side and are integrated into a single unit. The +D2-side plate surface of the retardation film 363, which is the surface parallel to a plane containing the D1 and D3 directions, is in contact with the light incident surface 210d of the cross dichroic prism 210 of the light combiner 200 from the −D2 side.

The antireflection film 361 prevents the green image light IG output from the light modulation element 182 from being reflected toward the −D2 side, and outputs substantially all the incident image light IG toward the +D2 side. The absorptive polarizing layer 362 is provided at the light exiting surface of the antireflection film 361 and is in contact with the +D2-side surface of the antireflection film 361, which is the surface parallel to a plane containing the D1 and D3 directions.

The absorptive polarizing layer 362 transmits the image light IG passing through the antireflection film 361, output from the antireflection film 361, and polarized in a predetermined polarization direction, and absorbs the image light IG passing through the antireflection film 361, output from the antireflection film 361 by a small amount, and polarized in the polarization directions other than the predetermined polarization direction. Note that when the amount of the image light IG output from the antireflection film 361 toward the +D2 side and polarized in the polarization directions other than the predetermined polarization direction is sufficiently small, the absorptive polarizing layer 362 may be omitted.

The retardation film 363 changes the polarization state of the image light IG output from the absorptive polarizing layer 362. The retardation film 363 functions in the same manner as a λ/4 wave plate, changes the polarization state of the incident image light IG, and converts, for example, linearly polarized light into circularly polarized light. The retardation film 363 is, for example, configured with a quartz crystal substrate.

FIG. 7 shows an example of the chief ray of the green light LG that enters the light guide 142 via the light incident end 142a and propagates directly to the light exiting end 142b without being incident on the reflection surfaces 142r even once out of the green light LG emitted via a light exiting surface 125a of the phosphor 125 in the light-emitter 422 of the light source 122.

The green light LG output toward the +D2 side from a position PG1 on the light exiting surface 125a of the phosphor 125 is non-polarized green light LGN, contains S-polarized light and P-polarized light, enters the light guide 142 via the light incident end 142a, is guided by the light guide 142 toward the +D2 side, and exits via the light exiting end 142b. The green light LGN output from the light guide 142 is parallelized along the D2 direction by the parallelizing element 162, and enters the retardation film 342 of the light-incident-side polarizer 172.

The green light LGN entering the retardation film 342 from the −D2 side passes through the retardation film 342 from the −D2 side toward the +D2 side. The polarization state of the green light LGN changes while the green light LGN passes through the retardation film 342, and the ratio between the S-polarized light and the P-polarized light contained in the green light LGN changes. The longitudinally polarized green light LGT out of the green light LGN output from the retardation film 342 and entering the reflective polarizing layer 343 sequentially passes through the reflective polarizing layer 343, the absorptive polarizing layer 344, and the antireflection film 345, and exits out of the light-incident-side polarizer 172 toward the +D2 side.

The laterally polarized green light LGH out of the green light LGN output from the retardation film 342 and entering the reflective polarizing layer 343 is reflected off the reflective polarizing layer 343, enters the retardation film 342 again from the +D2 side, and is converted into circularly polarized green light LGC when passing through the retardation film 342. The green light LGC contains S-polarized light and P-polarized light at the ratio of about 1:1. The green light LGC output from the retardation film 342 toward the −D2 side exits out of the light-incident-side polarizer 172 toward the −D2 side.

The green light LGC output from the light-incident-side polarizer 172 toward the −D2 side passes through the parallelizing element 162, enters the light guide 142 via the light exiting end 142b, is guided by the light guide 142 toward the −D2 side, and exits via the light incident end 142a. The green light LGC output from the light guide 142 toward the −D2 side is incident on a position PG2, which differs from the position PG1, on the light exiting surface 125a of the phosphor 125 in the light emitter 422 of the light source 122.

The phosphor 125 is excited with the green light LGC incident from the +D2 side, and emits the non-polarized green light LGN from the position PG2 on the light exiting surface 125a toward the +D2 side.

The green light LGN output from the position PG2 on the light exiting surface 125a of the phosphor 125 toward the +D2 side is guided from the −D2 side toward the +D2 side by the light guide 142 and output via the light exiting end 142b, as the green light LGN output from the position PG1 toward the +D2 side. The green light LGN output from the light guide 142 is parallelized along the D2 direction by the parallelizing element 162, and enters the retardation film 342 of the light-incident-side polarizer 172.

In the retardation film 342, the green light LGN incident from the −D2 side on the −D2-side light incident surface 342a parallel to a plane containing the D1 and D3 directions passes through the retardation film 342 from the −D2 side toward the +D2 side. The polarization state of the green light LGN changes while the green light LGN passes through the retardation film 342, and the green light LGN is converted into the vertically polarized green light LGT and the horizontally polarized green light LGH. The green light LGT output from the retardation film 342 and entering the reflective polarizing layer 343 sequentially passes through the reflective polarizing layer 343, the absorptive polarizing layer 344, and the antireflection film 345, and exits out of the light-incident-side polarizer 172 toward the +D2 side. The vibration direction of the green light LGT output from the light-incident-side polarizer 172 toward the +D2 side is, for example, parallel to the D2 direction.

The green light LGH output from the retardation film 342 and reflected off the reflective polarizing layer 343 enters the retardation film 342 again from the +D2 side, is converted into the circularly polarized green light LGC when passing through the retardation film 342, and exits out of the light-incident-side polarizer 172 toward the −D2 side, as described above. The green light LGC output from the light-incident-side polarizer 172 toward the −D2 side passes through the parallelizing element 162, is guided by the light guide 142 from the +D2 side toward the −D2 side, and enters the phosphor 125 of the light source 122 from the +D2 side, as described above.

The green light LGC entering the phosphor 125 from the +D2 side contributes to re-excitation of the phosphor 125, and the green light LGN is output via the light exiting surface 125a of the phosphor 125 toward the +D2 side. In the green light output portion 102, the aforementioned behaviors of the green light LGC, LGH, LGN, and LGT repeatedly occur.

The green light LGT output t from the light-incident-side polarizer 172 toward the +D2 side is converted into the image light IG by the light modulation element 182. The vibration direction of the image light IG output from the light modulation element 182 toward the +D2 side is, for example, parallel to the D1 direction. The vibration direction of the image light IG output from the light-exiting-side polarizer 176 toward the +D2 side includes, for example, multiple directions, as described above.

The image light IG output from the light modulation element 182, entering the light-exiting-side polarizer 176 from the −D2 side, and polarized in a predetermined polarization direction passes through the antireflection film 361 and the absorptive polarizing layer 362, and enters the retardation film 363. The image light IG polarized in the predetermined polarization direction and entering the retardation film 363 from the −D2 side is converted into circularly polarized light. The circularly polarized image light IG output from the light-exiting-side polarizer 176 toward the +D2 side enters the cross dichroic prism 210 of the light combiner 200 via the light incident surface 210d, as described above.

Note that the angle by which the crystal axis of the quartz crystal substrate 402, which constitutes the retardation film 342 of the light-incident-side polarizer 172, inclines with respect to the transmission axis of the reflective polarizing layer 343, the thickness of the quartz crystal substrate 402 in the D2 direction, and whether the quartz crystal substrate 402 is configured with a single plate or a bonded-two-piece quartz crystal substrate can be determined based on the results of the numerical calculation of the dependence of the amount of phase modulation made by the quartz crystal substrate 402 on the wavelength of the green light LG in consideration of the configuration of the single substrate or the configurations of the two substrates, and the spectrum of the green light LG output from the light source 122 and entering the quartz crystal substrate 402. Note that the retardation film 342 may include two or more quartz crystal substrates, and the two or more quartz crystal substrates may be layered on each other in the D2 direction.

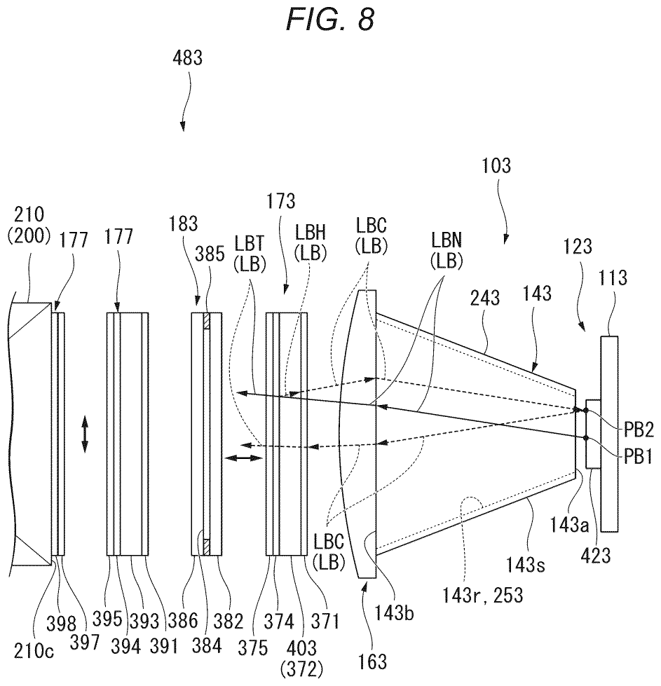

FIG. 8 is a schematic view of the blue light output portion 103 and the light modulator 483 of the optical module 310 according to the present embodiment.

The light-incident-side polarizer 173 of the light modulator 483 includes an antireflection film 371, a retardation film 372, an absorptive polarizing layer 374, and an antireflection film 375, as shown in FIG. 8. The antireflection film 371, the retardation film 372, the absorptive polarizing layer 374, and the antireflection film 375 are sequentially disposed from the +D1 side toward the −D1 side and are integrated into a single unit.

The antireflection film 371 is provided at the light incident surface of the retardation film 372, which is the surface on which the blue light LB is incident, and is in contact with the +D1-side surface of the retardation film 372 out of the surfaces thereof parallel to a plane containing the D2 and D3 directions. The antireflection film 371 prevents the blue light LB incident on the light-incident-side polarizer 173 from being reflected toward the +D1 side, outputs substantially all the incident blue light LB toward the −D1 side, and causes the blue light LB to enter the retardation film 372. The antireflection film 371 also outputs toward the +D1 side substantially all the blue light LB incident from the −D1 side, and outputs the blue light LB from the light-incident-side polarizer 173 toward the +D1 side.

The retardation film 372 corresponds to a second polarization converter, and changes the polarization state of the blue light LB entering the light-incident-side polarizer 173 and output from the antireflection film 371. The retardation film 372 functions in the same manner as a λ/4 wave plate, changes the polarization state of the incident blue light LB, and converts, for example, linearly polarized light into circularly polarized light or circularly polarized light into linearly polarized light.

The retardation film 372 is configured with a quartz crystal substrate 403. Since the retardation film 372 is the quartz crystal substrate 403, the heat dissipation capability of the retardation film 372 is enhanced, and the direction of the crystal axis and the polarization separation characteristic of the quartz crystal substrate 403 can be readily set in accordance with the thickness thereof in the D1 direction. Note that the retardation film 372 is made of an anisotropic material having a crystal axis along a predetermined direction, and may be configured, for example, with a substrate made of a sapphire single crystal other than quartz crystal.

Although not shown, the retardation film 372 may be configured with two quartz crystal substrates layered on each other in the D1 direction. When the retardation film 372 is configured with two substrates bonded to each other as described above, the first quartz crystal substrate disposed on the +D1 side out of the two quartz crystal substrates corresponds to a third quartz crystal substrate. In this case, the second quartz crystal substrate disposed on the −D1 side out of the two quartz crystal substrates corresponds to a fourth quartz crystal substrate.

Note when a reflective polarizing layer that is not shown is provided in the light-incident-side polarizer 173 as will be described later, the crystal axis of the retardation film 372 inclines, for example, by a predetermined angle with respect to the transmission axis of the reflective polarizing layer when viewed along the D1 direction. The predetermined angle is, for example, 75°. When the retardation film 372 is configured with two substrates bonded to each other as described above, the crystal axis of the quartz crystal substrate disposed on the +D1 side out of the two quartz crystal substrates corresponds to a third crystal axis, and inclines, for example, by an angle of 45° with respect to the transmission axis of the reflective polarizing layer. The crystal axis of the quartz crystal substrate disposed on the −D1 side out of the two quartz crystal substrates corresponds to a fourth crystal axis and inclines, for example, by an angle of 135° with respect to the transmission axis of the reflective polarizing layer. However, the angle by which the crystal axis of the quartz crystal substrate disposed on the +D1 side out of the two quartz crystal substrates inclines with respect to the transmission axis of the reflective polarizing layer and the angle by which the crystal axis of the quartz crystal substrate disposed on the −D1 side inclines with respect to the transmission axis of the reflective polarizing layer are not limited to those described above. For example, the angle by which the crystal axis of the quartz crystal substrate disposed on the +D1 side inclines with respect to the transmission axis of the reflective polarizing layer can be 15°, and the angle by which the crystal axis of the quartz crystal substrate disposed on the −D1 side inclines with respect to the transmission axis of the reflective polarizing layer can be 75°.

The reflective polarizing film that is not shown is provided at the light exiting surface of the retardation film 372, which is the surface via which the red light LR exits, and is in contact with the −D1-side surface of the retardation film 372 out of the surfaces thereof parallel to a plane containing the D2 and D3 directions. For example, in the D1 direction, the reflective polarizing layer that is not shown is disposed between the retardation film 372 and the absorptive polarizing layer 374. The reflective polarizing layer that is not shown corresponds to a second polarization separator, transmits longitudinally polarized blue light LBT out of the blue light LB passing through the retardation film 372 and output from the retardation film 372, and reflects laterally polarized blue light LBH out of the blue light LB passing through the retardation film 372 and output from the retardation film 372.

Specifically, when the light emitter 423 of the light source 123 has high reliability, and the amount of the blue light LB output from the light source 123 is sufficiently greater than the amount of the red light LR output from the light source 121 and the amount of the green light LG output from the light source 122, the reflective polarizing layer between the retardation film 372 and the absorptive polarizing layer 374 may be omitted as shown in FIG. 8. When the amount of the blue light LB is substantially equal to the amount of the red light LR, it is desirable to dispose the reflective polarizing layer that is not shown.

The blue light LBT passing through the reflective polarizing layer that is not shown corresponds to at least part of a second polarized component of the second light passing through the second polarization converter. The blue light LBH reflected off the reflective polarizing layer that is not shown corresponds to the other part of the second polarized component of the second light passing through the second polarization converter. The longitudinally polarized blue light LBT is, for example, S-polarized light. The laterally polarized blue light LBH is, for example, P-polarized light.

The absorptive polarizing layer 374 is provided at the light exiting surface of the retardation film 372 and is in contact with the −D1-side surface of the retardation film 372 out of the surfaces thereof along a plane containing the D2 and D3 directions. The absorptive polarizing layer 374 transmits the blue light LBT output from the retardation film 372, and absorbs the blue light LBH that is not shown but is output from the retardation film 372 by a small amount.

The antireflection film 375 is provided at the light exiting surface of the absorptive polarizing layer 374, and is in contact with the −D1-side surface of the absorptive polarizing layer 374 out of the surfaces thereof along a plane containing the D2 and D3 directions. The antireflection film 375 prevents the blue light LBT output from the absorptive polarizing layer 374 and incident from the −D1 side from being reflected toward the +D1 side, and outputs substantially all the incident blue light LBT toward the −D1 side.

The light modulation element 183 is configured with a transmissive liquid crystal panel as described above, and includes a counter substrate 382, a liquid crystal layer 384, a sealing member 385, and an element substrate 386. The counter substrate 382, the liquid crystal layer 384, the sealing member 385, and the element substrate 386 are integrated into a single unit.

The counter substrate 382 and the element substrate 386 are disposed so as to face each other in the D1 direction via the sealing member 385 having the shape of a frame. The liquid crystal layer 384 is disposed between the counter substrate 382 and the element substrate 386 in the D1 direction, and is surrounded by the sealing member 385 in a plane containing the D2 and D3 directions.

A counter electrode is provided at the −D1-side plate surface of the counter substrate 382, which is a surface parallel to a plane containing the D2 and D3 directions. Multiple pixel electrodes and switching elements corresponding to the multiple pixels are provided at the −D1-side plate surface of the element substrate 386, which is the surface parallel to a plane containing the D2 and D3 directions. The multiple pixel electrodes face the counter electrode via the liquid crystal layer 384 in the D1 direction.

The light-exiting-side polarizer 177 of the light modulator 483 includes an antireflection film 391, a retardation film 393, an absorptive polarizing layer 394, antireflection films 395 and 397, and a retardation film 398. The antireflection film 391, the retardation film 393, the absorptive polarizing layer 394, and the antireflection film 395 are sequentially disposed from the +D1 side toward the −D1 side, are integrated into a single unit, constitute a portion of the light-exiting-side polarizer 177, and are disposed between the light modulation element 183 and the light combiner 200 in the D1 direction. The antireflection film 397 and the retardation film 398 are sequentially disposed from the +D1 side toward the −D1 side, are integrated into a single unit, constitute the remainder of the light-exiting-side polarizer 177, and are disposed at the light incident surface 210e of the cross dichroic prism 210, which constitutes the light combiner 200.

The antireflection film 391 prevents the blue image light IB output from the light modulation element 183 from being reflected toward the +D1 side, and outputs substantially all the incident image light IB toward the −D1 side. The retardation film 393 is provided at the light exiting surface of the antireflection film 391, and changes the polarization state of the image light IB passing through the antireflection film 391.

The absorptive polarizing layer 394 is provided at the light exiting surface of the retardation film 393, transmits the image light IB output from the retardation film 393 and polarized in a predetermined polarization direction, and absorbs the image light IB output from the retardation film 393 and polarized in the polarization directions other than the predetermined polarization direction. Note that when the amount of the image light IB output from the retardation film 393 toward the −D1 side and polarized in the polarization directions other than the predetermined polarization direction is sufficiently small, the absorptive polarizing layer 394 may be omitted. The antireflection film 395 is provided at the light exiting surface of the absorptive polarizing layer 394, and prevents the blue image light IB output from the light modulation element 183 from being reflected toward the +D1 side, and outputs substantially all the incident image light IB toward the −D1 side.

The antireflection film 397 is disposed on the −D1 side of the antireflection film 395, prevents the image light IB output from the antireflection film 395 from being reflected toward the +D1 side, and outputs substantially all the incident image light IB toward the −D1 side. The retardation film 398 changes the polarization state of the image light IB output from the antireflection film 397. The retardation film 398 functions in the same manner as a λ/4 wave plate, changes the polarization state of the incident image light IB, and converts, for example, linearly polarized light into circularly polarized light. The retardation film 398 is configured, for example, with a known retardation film.

FIG. 8 shows an example of the chief ray of the blue light LB that enters the light guide 143 via the light incident end 143a and propagates directly to the light exiting end 143b without being incident on the reflection surfaces 143r even once out of the blue light LB emitted from the light emitter 423 of the light source 123.

The blue light LB output from a position PB1 on the light emission surface of the light emitter 423 toward the −D1 side is non-polarized blue light LBN, contains S-polarized light and P-polarized light, enters the light guide 143 via the light incident end 143a, is guided by the light guide 143 toward the −D1 side, and exits via the light exiting end 143b. The blue light LBN output from the light guide 143 is parallelized along the D1 direction by the parallelizing element 163, enters the light-incident-side polarizer 173, and passes through the antireflection film 371 of the light-incident-side polarizer 173.

The blue light LBN passing through the antireflection film 371 enters the retardation film 372 from the +D1 side and passes through the retardation film 372 from the +D1 side toward the −D1 side. The polarization state of the blue light LBN changes while the blue light LBN passes through the retardation film 372. Note that the polarization conversion performed by the retardation film 372 is performed on the blue light LB that can be caused by the absorptive polarizing layer 374 to return to the retardation film 372 and the blue light LB that is caused by a reflective polarizing layer or the like to return to the retardation film 372. For example, the longitudinally polarized blue light LBT out of the blue light LBN output from the retardation film 372 sequentially passes through the absorptive polarizing layer 374 and the antireflection film 375, and exits out of the light-incident-side polarizer 173 toward the −D1 side. For example, the laterally polarized blue light LBH out of the blue light LBN output from the retardation film 372 is absorbed by the absorptive polarizing layer 374.

The blue light LBT output from the light-incident-side polarizer 173 is converted into the blue image light IB by the light modulation element 183. The image light IB output from the light modulation element 183 sequentially passes through the antireflection film 391, the retardation film 393, the absorptive polarizing layer 394, and the antireflection film 395 of the light-exiting-side polarizer 177 from the −D1 side toward the +D1 side. The image light IB output from the absorptive polarizing layer 394 toward the −D1 side is light polarized in a predetermined polarization direction.

The image light IB output from the antireflection film 397 sequentially passes through the antireflection film 397 and the retardation film 398 of the light-exiting-side polarizer 177 from the −D1 side toward the +D1 side. The image light IB output from the retardation film 398 toward the −D1 side contains S-polarized light and P-polarized light.

Note that when the reflective polarizing layer that is not shown is provided between the retardation film 372 and the absorptive polarizing layer 374 in the light-incident-side polarizer 173 shown in FIG. 8 as described above, the laterally polarized blue light LBH out of the blue light LBN output from the retardation film 372 and entering the reflective polarizing layer is reflected off the reflective polarizing layer, enters the retardation film 372 again from the −D1 side, and is converted into the circularly polarized blue light LBC when passing through the retardation film 372. The blue light LBC contains S-polarized light and P-polarized light. The blue light LBC output from the retardation film 372 toward the +D1 side passes through the antireflection film 371 and exits out of the light-incident-side polarizer 173 toward the +D1 side.

The blue light LBC output from the light-incident-side polarizer 173 toward the +D1 side passes through the parallelizing element 163, enters the light guide 143 via the light exiting end 143b, is guided by the light guide 143 toward the +D1 side, and exits via the light incident end 143a. At least part of the blue light LBC output from the light guide 143 toward the +D1 side is reflected at a position PB2, which differs from the position PB1, on the light emission surface of the light emitter 423 of the light source 123 toward the −D1 side. When reflected off the light emission surface of the light emitter 423, the polarization state of the blue light LBC does not change but remains circularly polarized.

The blue light LBC reflected off the light emission surface of the light emitter 423 of the light source 123 toward the −D1 side is guided by the light guide 143 toward the −D1 side, and exits via the light exiting end 143b. The blue light LBC output from the light guide 143 passes through the parallelizing element 163, enters the light-incident-side polarizer 173, and passes through the antireflection film 371 of the light-incident-side polarizer 173.

The blue light LBC passing through the antireflection film 371 enters the retardation film 372 from the +D1 side and passes through the retardation film 372. The polarization state of the blue light LBC changes while the blue light LBC passes through the retardation film 372, and the blue light LBC is converted into the longitudinally polarized blue light LBT. The blue light LBT output from the retardation film 372 and entering the absorptive polarizing layer 374 sequentially passes through the absorptive polarizing layer 374 and the antireflection film 375, and exits out of the light-incident-side polarizer 173 toward the −D1 side. The vibration direction of the blue light LBT output from the light-incident-side polarizer 173 toward the −D1 side is, for example, parallel to the D1 direction.

The blue light LBT output from the light-incident-side polarizer 173 toward the −D1 side is converted into the image light IB by the light modulation element 183. The vibration direction of the image light IB output from the light modulation element 183 toward the −D1 side is, for example, parallel to the D2 direction. The vibration direction of the image light IB output from the retardation film 398 of the light-exiting-side polarizer 177 toward the −D1 side includes, for example, multiple directions, as described above.

The image light IB output from the light modulation element 183, entering the light-exiting-side polarizer 177 from the −D1 side, and polarized in a predetermined polarization direction passes through the antireflection film 391, the retardation film 393, the absorptive polarizing layer 394, and the antireflection film 395, and is converted into the image light IB polarized again in the predetermined polarization direction. The image light IB polarized in the predetermined polarization direction, output from the antireflection film 395, and entering the antireflection film 397 from the +D1 side is converted by the retardation film 398, for example, into circularly polarized light. The image light IB output from the light-exiting-side polarizer 177 toward the −D1 side enters the cross dichroic prism 210 of the light combiner 200 via the light incident surface 210e, as described above.

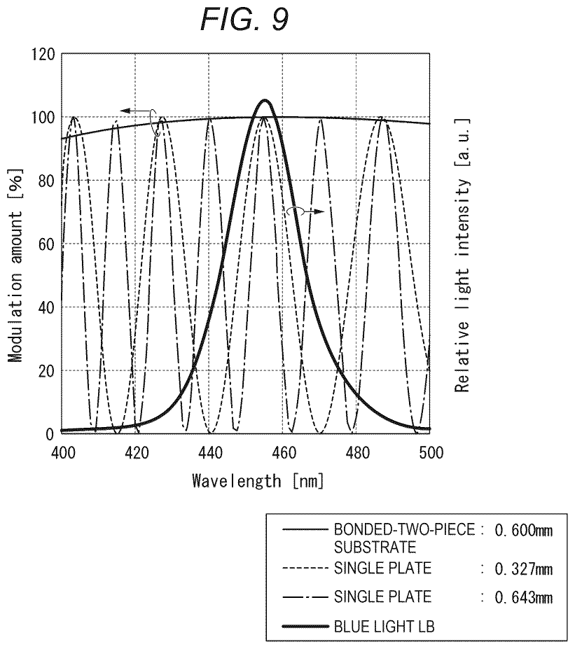

FIG. 9 shows graphs illustrating an example of results of numerical calculation of the dependence of the amount of phase modulation made by the single-plate quartz crystal substrate 403, which constitutes the retardation film 372, for the blue light LB on the thickness of the quartz crystal substrate 403, and the spectrum of the blue light LB entering the quartz crystal substrate 403. In the present numerical calculation, the thickness of the single-plate quartz crystal substrate 403, which is configured with a single quartz crystal substrate, in the D1 direction was changed between 0.327 mm and 0.643 mm. The thickness of the bonded-two-piece quartz crystal substrate 403, which is configured with two quartz crystal substrates, in the D1 direction was set at 0.600 mm. The angle by which the crystal axis of the single-plate quartz crystal substrate 403 inclines with respect to the transmission axis of the reflective polarizing layer that is not shown was set at 45°. As for the bonded-two-piece quartz crystal substrate 403, it was assumed that the crystal axis of the +D1-side quartz crystal substrate inclines by the angle of 45° with respect to the transmission axis of the reflective polarizing layer that is not shown, and the crystal axis of the −D1-side quartz crystal substrate inclines by the angle of 135° with respect to the transmission axis of the reflective polarizing layer that is not shown.

The half width of the profile of the amount of phase modulation made by the quartz crystal substrate 403 configured with a single plate is considerably smaller than the half width of the profile of the amount of phase modulation made by the quartz crystal substrate 403 configured with two quartz crystal substrates bonded to each other regardless of whether the thickness of the quartz crystal substrate 403 is 0.327 mm or 0.643 mm, and is smaller than the half width of the spectrum of the blue light LB, which is about 20 nm, as shown in FIG. 9.

When the thickness of the quartz crystal substrate 403 is 0.327 mm and 0.643 mm, and the quartz crystal substrate 403 is configured with a single plate, the polarization state of part of the incident blue light LB can be changed, but it is difficult for the quartz crystal substrate 403 of the retardation film 372 to change the polarization state of the primary blue light LB having a wavelength band greater than or equal to at least the half value of the spectrum profile of the blue light LB but smaller than or equal to the maximum value of the spectrum profile. The configuration in which the quartz crystal substrate 403 is configured with a single plate can suppress the cost of the quartz crystal substrate 403 and hence the projector 350.

When the thickness of the quartz crystal substrate 403 is 0.600 mm, and the quartz crystal substrate 403 is configured with a bonded-two-piece quartz crystal substrate as described above, the quartz crystal substrate 403 constituting the retardation film 372 can change the polarization state of the incident blue light LB within the entire wavelength band greater than or equal to minimum value of the light intensity of the blue light LB, that is, zero but smaller than or equal to the maximum value of the light intensity of the blue light LB, so that the polarization conversion performance of the quartz crystal substrate 403 can be enhanced as compared with the case where the quartz crystal substrate 403 is configured with a single plate.

The angle by which the crystal axis of the quartz crystal substrate 403 inclines with respect to the transmission axis of the reflective polarizing layer that is not shown, the thickness of the quartz crystal substrate 403 in the D1 direction, and whether the quartz crystal substrate 403 is configured with a single plate or a bonded-two-piece quartz crystal substrate can be determined based on results of numerical calculation of the dependence of the amount of phase modulation made by the quartz crystal substrate 403 on the wavelength of the blue light LB in consideration of the configuration of the single substrate or the configurations of the two substrates, and the spectrum of the blue light LB output from the light source 123 and entering the quartz crystal substrate 403. Note that the retardation film 372 may include two or more quartz crystal substrates, and the two or more quartz crystal substrates may be layered on each other in the D1 direction.

The optical module 310 according to the present embodiment described above includes the light source (first light source) 121, the light guide (first light guide) 141, the parallelizing element (first parallelizing element) 161, and the light modulator (first light modulator) 481. The light source 121 outputs the red light (first light) LR having a wavelength band including the red wavelength band (first wavelength band). The light guide 141 has the light incident end (first light incident end) 141a, on which the red light LR output from the light source 121 is incident, and the light exiting end (first light exiting end) 141b, via which the red light LR exits, and homogenizes the illuminance of the red light LR in a plane containing the D2 and D3 directions (in-plane illuminance). The parallelizing element 161 parallelizes the red light LR output from the light guide 141. The light modulation element 181 modulates the red light LR output from the parallelizing element 161 based on image information. The light-incident-side polarizer 171 of the light modulator 481 includes the retardation film (first polarization converter) 312 and the reflective polarizing layer (first polarization separator) 313. The retardation film 312 changes the polarization state of the red light LR output from the parallelizing element 161 and entering the light-incident-side polarizer 171. The reflective polarizing layer 313 transmits the longitudinally polarized red light (at least part of first polarized component) LRT out of the red light LR passing through the retardation film 312, and reflects the laterally polarized red light (another part) LRH out of the red light LR passing through the retardation film 312. In the optical module 310 according to the present embodiment, the retardation film 312 changes the polarization state of the red light LRH reflected off the reflective polarizing layer 313 (other part of first light).

In the optical module 310 according to the present embodiment, for example, an LED that emits color light containing not only a specific polarized component but also all polarized components, for example, non-polarized light including randomly polarized light is employed as the light emitter 421 of the light source 121. Only the color light configured with the specific polarized component corresponding to the first polarized component of the red light LR output from the light source 121, that is, only the longitudinally polarized red light LRT is converted by the light modulation element 181 into the red image light IR, which is used to form an image based on the image light output from the optical module 310.

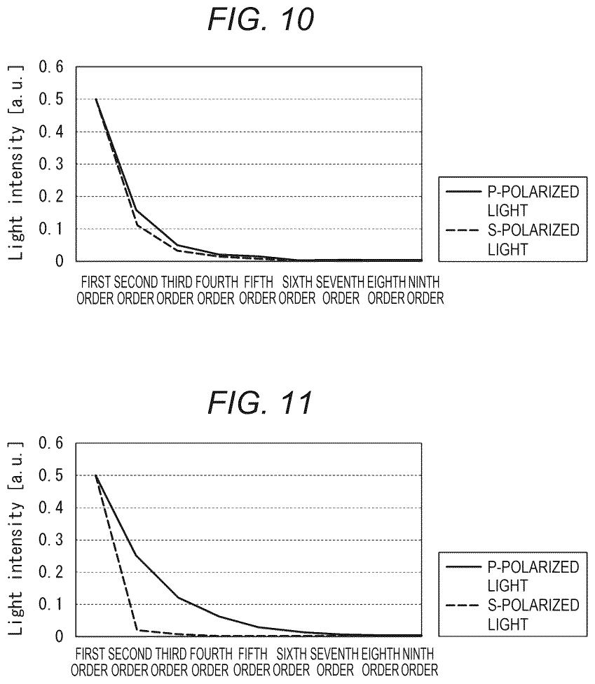

FIG. 10 shows diagrammatic graphs illustrating the ratio between the polarization states of the red light LR of each order entering the reflective polarizing layer 313 from the −D1 side in the light-incident-side polarizer 171 of the light modulator 481 of the optical module 310 according to the present embodiment. The first-order red light LR that is first output from the position PR1 or the like on the light emission surface of the light emitter 421 of the light source 121 and entering the reflective polarizing layer 313 from the −D1 side contains P-polarized light corresponding to the laterally polarized light and S-polarized light corresponding to the longitudinally polarized light at a ratio of about 50%:50%, as shown in FIG. 10.

Since the polarization state of the second-order red light LR reflected off the reflective polarizing layer 313, output from the position PR2 or the like on the light emission surface of the light emitter 421 of the light source 121 toward the +D1 side, and entering the reflective polarizing layer 313 from the −D1 side is changed by the retardation film 312, the proportion of the second-order longitudinally polarized red light LRT, that is, the S-polarized light and the proportion of the second-order laterally polarized red light LRH, that is, the P-polarized light are each approximately greater than or equal to 10% but smaller than or equal to 20%. Since the retardation film 312 is disposed on the −D1 side of the reflective polarizing layer 313, the polarization state of the red light LR that returns from the +D1 side to the light emitter 421 of the light source 121 and is reflected toward the −D1 side changes, so that the proportions of the red light LRT and LRH decrease as the order of the red light LR increases, and the high-order red light LRH contributes to the generation of the image light IR.

FIG. 11 shows diagrammatic graphs illustrating the ratio of the polarization states of the red light of each order entering a reflective or absorptive polarizer in a light-incident-side polarizer plate in a light-incident-side polarizer of a light modulator of an optical module of related art without the retardation film 312. Since an element corresponding to the retardation film 312 is not provided in the optical module of related art, the proportion of the S-polarized light passing through the polarizer plate out of the second-order red light is about 0%, and the proportion of the P-polarized light blocked by the polarizer plate out of the second-order red light is about 25%, as shown in FIG. 11. In the optical module of related art, the P-polarized light out of the high-order red light stays between a light source apparatus and the polarizer plate in the light-incident-side polarizer of the light modulator, or becomes stray light or the like inside an exterior body of the projector, and therefore does not contribute to the generation of the image light IR. As a result, in the optical module of related art without the retardation film 312, the light use efficiency decreases.

The optical module 310 according to the present embodiment, in which the retardation film 312 is disposed on the −D1 side of the reflective polarizing layer 313 and the retardation film 312 facilitates the conversion of the polarization state of the red light LR, allows at least both the S-polarized light and the P-polarized light of the red light LR output from the light source 121 to be used to form an image, so that a decrease in light use efficiency can be suppressed as compared with the optical module of related art.

Note in the optical module 310 according to the present embodiment that when the light-incident-side polarizer 173 of the light modulator 483 includes a reflective polarizing layer that is not shown, the ratio of the polarization states of the blue light LB of each order changes as the ratio of the polarization states of the red light LR of each order shown in FIG. 10 by way of example, so that the efficiency at which the blue light LB is used increases.

The optical module 310 according to the present embodiment further includes the light source (second light source) 123, the light source (third light source) 122, the light guide (second light guide) 143, the light guide (third light guide) 142, the parallelizing element (second parallelizing element) 163, the parallelizing element (third parallelizing element) 162, the light modulator (second light modulator) 483, the light modulator (third light modulator) 482, and the light combiner 200. The light source 123 outputs the blue light (second light) LB having a wavelength band including the blue wavelength band (second wavelength band) different from the red wavelength band. The light source 122 outputs the green light (third light) LG having a wavelength band including the green wavelength band (third wavelength band) different from the red wavelength band and the blue wavelength band. The light guide 142 has the light incident end (third light incident end) 142a, on which the green light LG output from the light source 122 is incident, and the light exiting end (third light exiting end) 142b, via which the green light LG exits, and homogenizes the illuminance of the green light LG in a plane containing the D1 and D3 directions (in-plane illuminance). The light guide 143 has the light incident end (second light incident end) 143a, on which the blue light LB output from the light source 123 is incident, and the light exiting end (second light exiting end) 143b, via which the blue light LB exits, and homogenizes the illuminance of the blue light LB in a plane containing the D2 and D3 directions (in-plane illuminance). The parallelizing element 162 parallelizes the green light LG output from the light guide 142. The parallelizing element 163 parallelizes the blue light LB output from the light guide 143. The light modulation element 182 modulates the green light LG output from the light guide 142 based on image information. The light modulation element 183 modulates the blue light LB output from the light guide 143 based on image information. The light combiner 200 combines the image light (first light) IR output from the light modulation element 181, the image light (second light) IB output from the light modulation element 183, and the image light (third light) IG output from the light modulation element 182 with one another and outputs the combined light.

The optical module 310 according to the present embodiment, which has the three-plate configuration, can form, for example, bright color image light generated by red, blue, and green image light.

In the optical module 310 according to the present embodiment, the retardation film 312 is configured with the quartz crystal substrate 401.

The optical module 310 according to the present embodiment, in which the first polarization converter can be readily realized at low cost, can enhance the heat dissipation capability in the light-incident-side polarizer 171.

In the optical module 310 according to the present embodiment, the quartz crystal substrate 401 has the crystal axis J2, and the reflective polarizing layer 313 has the transmission axis J1, along which the reflective polarizing layer 313 transmits the red light LRT. When viewed along the optical axis AXR of the red light LR entering the light-incident-side polarizer 171 of the light modulator 481, the angle θ1 between the crystal axis J2 and the transmission axis J1 is greater than 0° but smaller than 90°.

In the optical module 310 according to the present embodiment, the crystal axis J2 can be shifted from the transmission axis J1 in the circumferential direction around the optical axis AXR to appropriately set the angle θ1, so that a desired polarization conversion characteristic of the retardation film 312 can be realized.

In the optical module 310 according to the present embodiment, the angle θ1 is 45°, so that the thickness of the quartz crystal substrate 401 can be appropriately set to readily realize a desired polarization conversion characteristic of the retardation film 312.

In the optical module 310 according to the present embodiment, the first light is the red light LR.

In the optical module 310 according to the present embodiment, when the amount of the red light LR emitted from the light emitter 421 of the light source 121 is smaller than a desired amount, or even when the amount of the red light LR is smaller than the amount of the green light LG emitted from the light emitter 422 of the light source 122 and the amount of the blue light LB emitted from the light emitter 423 of the light source 123, the efficiency at which the red light LR is used can be increased. As a result, the color balance of the color light and the image light IM output from the optical module 310 according to the present embodiment can also be enhanced.

In the optical module 310 according to the present embodiment, the thickness of the quartz crystal substrate 401 ranges from 0.250 mm to 0.650 mm.

The optical module 310 according to the present embodiment can favorably change the polarization state of most of the red light LR entering the quartz crystal substrate 401.

In the optical module 310 according to the present embodiment, the quartz crystal substrate 401 includes the first quartz crystal substrate 411 and the second quartz crystal substrate 412. The first quartz crystal substrate has the first crystal axis J11. The second quartz crystal substrate has the second crystal axis J12. The reflective polarizing layer 313 has the transmission axis J1. When viewed along the optical axis AXR of the red light LR entering the light-incident-side polarizer 171 of the light modulator 481, the angle θ11 between the first crystal axis J11 and the transmission axis J1 is 15°, and the angle θ12 between the second crystal axis J12 and the transmission axis J1 is 75°.

The optical module 310 according to the present embodiment can increase the amount of phase modulation made by the quartz crystal substrate 401, ensure a relatively wide wavelength band that allows a large amount of phase modulation, and favorably and efficiently change the polarization state of most of the red light LR entering the quartz crystal substrate 401.

In the optical module 310 according to the present embodiment, the thickness of the first quartz crystal substrate 411 ranges from 0.300 mm to 0.400 mm, and the thickness of the second quartz crystal substrate 412 ranges from 0.100 mm to 0.200 mm.

The optical module 310 according to the present embodiment can readily adjust the polarization conversion characteristic of the quartz crystal substrate 401 and efficiently change the polarization state of most of the red light LR entering the quartz crystal substrate 401.

In the optical module 310 according to the present embodiment, the −D1-side of the reflective polarizing layer 313, which is the surface on which the red light LR is incident, is in contact with the +D1-side surface of the retardation film 312, which is the surface via which the red light LR exits, and the retardation film 312 and the reflective polarizing layer 313 are integrated with each other.

In the optical module 310 according to the present embodiment, the polarization conversion efficiency of the light-incident-side polarizer 171 can be increased, and the light-incident-side polarizer 171 can be reduced in size in the D1 direction.

In the optical module 310 according to the present embodiment, the light guide 141 has a quadrangular cross-sectional shape perpendicular to the optical axis and the D1 direction.

In the optical module 310 according to the present embodiment, the red light LR having a quadrangular shape and uniform illuminance in a plane perpendicular to the optical axis of the red light can be readily generated by the light guide 141. The optical module 310 according to the present embodiment can readily generate the red light having a quadrangular shape that matches the shape of the light modulation surface of the light modulation element 181.

In the optical module 310 according to the present embodiment, the cross-sectional area of the light exiting end 141b of the light guide 141 is greater than the cross-sectional area of the light incident end 141a of the light guide 141.

In the optical module 310 according to the present embodiment, the illuminance distribution of the red light LR is homogenized, and the area irradiated with the red light LR is increased after the red light LR enters the light guide 141 via the light incident end 141a but before the red light LR exits out of the light guide 141 via the light exiting end 141b. The optical module 310 according to the present embodiment, in which the illuminance distribution of the red light LR output from the light source 121 can be homogenized in a plane perpendicular to the optical axis of the red light LR, and the size of the red light LR, that is, the area irradiated with the red light LR in the plane perpendicular to the optical axis of the red light LR can be readily increased in accordance with the light modulation surface of the light modulation element 183.

In the optical module 310 according to the present embodiment, when viewed along the optical axis of the red light LR entering the light modulator 481, the light modulation surface of the light modulation element 181 has a quadrangular shape, and the light incident surface of each of the retardation film 312 and the reflective polarizing layer 313 has a quadrangular shape.

The optical module 310 according to the present embodiment, in which the light incident surface of each of the retardation film 312 and the reflective polarizing layer 313 has a quadrangular shape, as the light modulation surface of the light modulation element 181, can readily output the red light LR having a beam shape that matches the light modulation surface of the light modulation element 181 from the reflective polarizing layer 313 of the light-incident-side polarizer 171, and cause the red light LR output from the light-incident-side polarizer 171 to enter the light modulation element 181, so that a decrease in the efficiency at which the red light LR is used can be suppressed.

The projector 350 according to the present embodiment includes the optical module 310 according to the present embodiment described above, and the projection system 390, which projects the image light (light) IM output from the optical module 310. The light source 121 includes the light emitter (first light emitter) 421, which emits the red light LR. The light source 123 includes the light emitter (second light emitter) 423, which emits the blue light LB. The light emitter 422 of the light source 122 includes the LED body (third light emitter) 124, and the phosphor (wavelength conversion element) 125. The LED body 124 outputs, for example, blue light (fourth light) as the excitation light. The phosphor 125 converts the blue light output from the LED body 124 into the green light LG.

In the projector 350 according to the present embodiment, the light-incident-side polarizer 171 of the light modulator 481, which modulates, for example, the red light LR as the first light from the light source 121 including no phosphor, includes the retardation film 312 and the reflective polarizing layer 313. The light-incident-side polarizer 173 of the light modulator 483, which modulates, for example, the blue light LB as the second light from the light source 123 including no phosphor but being highly reliable, may not include a retardation film or a reflective polarizing layer. The light-incident-side polarizer 172 of the light modulator 482, which modulates the green light LG from the light source 122 including the phosphor 125 may not include a retardation film or a reflective polarizing layer. The projector 350 according to the present embodiment can use color light the amount of which is likely to be relatively insufficient at increased efficiency, such as the red light LR output from the light source 121, which outputs at least the red light LR.

Note in the projector 350 according to the present embodiment that the light-incident-side polarizer 172 of the light modulator 482 includes the retardation film 342 and the reflective polarizing layer 343, and the green light LG reflected off the reflective polarizing layer 343 toward the −D2 side contributes to the re-excitation of the phosphor 125. The projector 350 according to the present embodiment allows improvement in the efficiency at which the green light LG is used, which is, however, likely to be lower than the improvement in the efficiency at which the red light LR is used.

In the projector 350 according to the present embodiment, the light modulator 483 may include the retardation film 372 and a reflective polarizing layer that is not shown. The retardation film 372 changes the polarization state of the blue light LB output from the parallelizing element 163. The reflective polarizing layer that is not shown transmits the longitudinally polarized blue light (at least part of second polarized component) LBT out of the blue light LB passing through the retardation film 372, and reflects the laterally polarized blue light (another part) LBH out of the blue light LB passing through the retardation film 372. In the projector 350 according to the present embodiment, the retardation film 372 changes the polarization state of the blue light LBH reflected off the reflective polarizing layer that is not shown (other part of second light).

In the projector 350 according to the present embodiment, for example, an LED that emits color light containing not only a specific polarized component but also all polarized components, for example, non-polarized light including randomly polarized light is employed as the light emitter 423 of the light source 123, as in the case of the light emitter 421 of the light source 121. Only the color light configured with the specific polarized component corresponding to the second polarized component of the blue light LB output from the light source 123, that is, only the longitudinally polarized blue light LBT is converted by the light modulation element 183 into the blue image light IB, which is used to form an image based on the image light IM output from the optical module 310. The projector 350 according to the present embodiment can increase the efficiency at which the blue light LB is used in addition to the efficiency at which the red light LR is used.

In the projector 350 according to the present embodiment, the first light is the red light LR, and the light-incident-side polarizer 171 of the light modulator 481 includes the retardation film 312 and the reflective polarizing layer 313. The light-incident-side polarizer 173 of light modulator 483 does not include a polarization converter, a retardation film, or the like that changes the polarization state of the blue light LB output from the parallelizing element 163. The light-incident-side polarizer 172 of the light modulator 482 does not include a polarization converter, a retardation film, or the like that changes the polarization state of the green light LG output from the parallelizing element 162.

In the projector 350 according to the present embodiment, when only the light-incident-side polarizer 171 of the light modulator 481 out of the light-incident-side polarizers 171, 172, and 173 of the light modulators 481, 482, and 483 includes the retardation film 312, color light the amount of which is likely to be relatively insufficient can be reliably used at increased efficiency, such as the red light LR output from the light source 121.

In the projector 350 according to the present embodiment, the quartz crystal substrate 403 is configured with a quartz crystal substrate (third quartz crystal substrate) as the −D1-side substrate of the bonded-two-piece substrate, and a quartz crystal substrate (fourth quartz crystal substrate) as the +D1-side substrate of the bonded-two-piece substrate. The third quartz crystal substrate has a third crystal axis. The fourth quartz crystal substrate has a fourth crystal axis. The reflective polarizing layer that is not shown has a transmission axis. When viewed along the optical axis of the blue light LB entering the light-incident-side polarizer 173 of the light modulator 483, the angle between the third crystal axis and the transmission axis of the reflective polarizing layer that is not shown is 45°, and the angle between the fourth crystal axis and the transmission axis of the reflective polarizing layer that is not shown is 135°.

The projector 350 according to the present embodiment can increase the amount of phase modulation made by the quartz crystal substrate 403, ensure a relatively wide wavelength band that allows a large amount of phase modulation, and favorably and efficiently change the polarization state of most of the blue light LB entering the quartz crystal substrate 403.

A preferable embodiment of the present disclosure has been described above in detail. The present disclosure is, however, not limited to the specific embodiment, and various modifications and changes can be made thereto within the scope of the key points of the present disclosure disclosed in the claims.

For example, in the red light output portion 101 and the blue light output portion 103, the LEDs constituting the light sources 121 and 123 may contain phosphors that are excited with the light from the LED bodies to emit the red light LR and the blue light LB, as in the green light output portion 102. In the green light output portion 102, the light emitter 422 of the light source 122 may include no phosphor but may be configured only with the LED body that emits the green light LG. In the optical module according to the present embodiment, it is desirable that the light modulator corresponding to a color light source including a light emitter including no phosphor includes the same light-incident-side polarizer as the light-incident-side polarizer 171 including the retardation film 312 and the reflective polarizing layer 313, as the light modulator 481 of the optical module 310.

For example, the light guides 141, 142, and 143 may each be a reflector made of a transparent material having a refractive index higher than that of air, such as optical glass and quartz, or may be formed as a solid member. When the light guides 141, 142, and 143 are each a solid member configured with the transparent member described above, the reflection surfaces 141r, 142r, and 143r are configured with side surfaces of the solid member that face outward. Most of each of the red light LR, the green light LG, and the blue light LB entering the light guides 141, 142, and 143 via the light incident ends 141a, 142a, and 143a is totally reflected off the reflection surfaces 141r, 142r, and 143r toward the light exiting ends 141b, 142b, and 143b.

For example, the light-exiting-side polarizer 175 of the light modulator 481 may not include the retardation film 333. The light-exiting-side polarizer 177 of the light modulator 483 may not include one or both of the retardation film 393 and the retardation film 398.

### SUMMARY OF PRESENT DISCLOSURE

The present disclosure is summarized below as additional remarks.

(Additional Remark 1) An optical module including: a first light source configured to output first light having a first wavelength band; a first light guide having a first light incident end on which the first light output from the first light source is incident and a first light exiting end via which the first light exits, and configured to homogenize in-plane illuminance of the first light; a first parallelizing element configured to parallelize the first light output from the first light guide; and a first light modulator configured to modulate the first light output from the first parallelizing element based on image information, wherein the first light modulator includes a first polarization converter configured to change a polarization state of the first light output from the first parallelizing element, and a first polarization separator configured to transmit at least part of a first polarized component of the first light passing through the first polarization converter and reflect another part of the first light, and the first polarization converter is configured to change a polarization state of the other part of the first light reflected off the first polarization separator.

According to the configuration described in Additional Remark 1, since the first polarization converter is disposed at a position shifted from the first polarization separator toward the side toward which the first light travels, and the conversion of the polarization state of the first light is therefore facilitated by the first polarization converter, so that at least both the S-polarized light and the P-polarized light of the first light output from the first light source are used to form an image, and a decrease in the efficiency at which the optical module uses the light can therefore be suppressed as compared with the related art.

(Additional Remark 2) The optical module according to Additional Remark 1, further including: a second light source configured to output second light having a second wavelength band different from the first wavelength band; a third light source configured to output third light having a third wavelength band different from the first wavelength band and the second wavelength band; a second light guide having a second light incident end on which the second light output from the second light source is incident and a second light exiting end via which the second light exits, and configured to homogenize in-plane illuminance of the second light; a third light guide having a third light incident end on which the third light output from the third light source is incident and a third light exiting end via which the third light exits, and configured to homogenize in-plane illuminance of the third light; a second parallelizing element configured to parallelize the second light output from the second light guide; a third parallelizing element configured to parallelize the third light output from the third light guide; a second light modulator configured to modulate the second light output from the second parallelizing element based on image information; a third light modulator configured to modulate the third light output from the third parallelizing element based on image information; and a light combiner configured to combine the first light output from the first light modulator, the second light output from the second light modulator, and the third light output from the third light modulator with one another and output the combined light.

The configuration described in Additional Remark 2 constitutes a three-plate optical module, and can form, for example, bright color image light generated by red, blue, and green image light.

(Additional Remark 3) The optical module according to Additional Remark 1 or 2, wherein the first polarization converter is configured with a quartz crystal substrate.

According to the configuration described in Additional Remark 3, the first polarization converter can be readily realized at low cost, and heat dissipation capability of the light-incident-side polarizer of the first light modulator can be enhanced.

(Additional Remark 4) The optical module according to any of Additional Remarks 1 to 3, wherein the quartz crystal substrate has a crystal axis, the first polarization separator has a transmission axis, and an angle between the crystal axis and the transmission axis is greater than 0° but smaller than 90° when viewed along an optical axis of the first light entering the first light modulator.

The configuration described in Additional Remark 4 can shift the crystal axis from the transmission axis in the circumferential direction around the optical axis of the first light entering the light-incident-side polarizer of the first light modulator to appropriately set the angle between the crystal axis and the transmission axis, so that a desired polarization conversion characteristic of the first polarization converter can be realized.

(Additional Remark 5) The optical module according to Additional Remark 4, wherein the angle is 45°.

According to the configuration described in Additional Remark 5, the thickness of the quartz crystal substrate of the first polarization converter can be appropriately set, so that a desired polarization conversion characteristic of the first polarization converter can be readily realized.

(Additional Remark 6) The optical module according to Additional Remark 5, wherein the first light is red light.

According to the configuration described in Additional Remark 6, for example, even when the amount of the red light output from the first light source is smaller than the amounts of the other types of color light, the efficiency at which the red light is used can be increased, so that the color balance of the color light and the image light output from the optical module can be increased.

(Additional Remark 7) The optical module according to Additional Remark 5 or 6, wherein a thickness of the quartz crystal substrate ranges from 0.250 mm to 0.650 mm.

The configuration described in Additional Remark 7 can favorably change and adjust the polarization state of most of the first light entering the quartz crystal substrate of the first polarization converter.

(Additional Remark 8) The optical module according to Additional Remark 3, wherein the quartz crystal substrate is configured with a first quartz crystal substrate and a second quartz crystal substrate integrated with each other, the first quartz crystal substrate has a first crystal axis, the second quartz crystal substrate has a second crystal axis, the first polarization separator has a transmission axis, and when viewed along an optical axis of the first light entering the first light modulator, an angle between the first crystal axis and the transmission axis is 15°, and an angle between the second crystal axis and the transmission axis is 75°.

The configuration described in Additional Remark 8 can increase the amount of phase modulation made by the quartz crystal substrate of the first polarization converter, ensure a relatively wide wavelength band that allows a large amount of phase modulation, and favorably and efficiently change the polarization state of most of the first light entering the quartz crystal substrate.

(Additional Remark 9) The optical module according to Additional Remark 8, wherein a thickness of the first quartz crystal substrate ranges from 0.300 mm to 0.400 mm, and a thickness of the second quartz crystal substrate ranges from 0.100 mm to 0.200 mm.

The configuration described in Additional Remark 9 can readily adjust the polarization conversion characteristic of the quartz crystal substrate of the first polarization converter and efficiently change the polarization state of most of the first light entering the quartz crystal substrate.

(Additional Remark 10) The T optical module according to any of Additional Remarks 1 to 9, wherein a light incident surface of the first polarization separator on which the first light is incident is in contact with a light exiting surface of the first polarization converter via which the first light exits, and the first polarization separator and the first polarization converter are integrated with each other.

The configuration described in Additional Remark 10 can increase the polarization conversion efficiency of the light-incident-side polarizer of the first light modulator, and reduce the size of the light-incident-side polarizer of the first light modulator.

(Additional Remark 11) The optical module according to any of Additional Remarks 1 to 10, wherein the first light guide has a quadrangular cross-sectional shape.

According to the configuration described in Additional Remark 11, the first light guide can readily generate first light having a quadrangular shape and uniform illuminance in a plane perpendicular to the optical axis of the color light, and can further readily generate the color light having a quadrangular shape that matches the shape of the light modulation surface of the first light modulator.

(Additional Remark 12) The optical module according to any of Additional Remarks 1 to 10, wherein a cross-sectional area of the first light exiting end is greater than a cross-sectional area of the first light incident end.

The configuration described in Additional Remark 12 can homogenize the illuminance distribution of the first light in a plane perpendicular to the optical axis, and the size of the first light in the plane perpendicular to the optical axis, that is, the area irradiated with the first light can be readily increased in accordance with the light modulation surface of a light modulation element of the first light modulator.

(Additional Remark 13) The optical module according to Additional Remark 11, wherein when viewed along an optical axis of the first light entering the first light modulator, a light modulation surface of the first light modulator has a quadrangular shape, and a light incident surface of the first polarization separator has a quadrangular shape.

According to the configuration described in Additional Remark 13, first light having a beam shape that matches the shape of the light modulation surface of the light modulation element can be readily output from the first polarization separator of the light-incident-side polarizer of the first light modulator, so that a decrease in the efficiency at which the first light is used can be reduced.

(Additional Remark 14) A projector including: the optical module according to any of Additional Remarks 2 to 13; and a projection system configured to project light output from the optical module, wherein the first light source includes a first light emitter configured to emit the first light, the second light source includes a second light emitter configured to emit the second light, and the third light source includes a third light emitter configured to emit fourth light, and a wavelength conversion element configured to convert the fourth light emitted from the third light emitter into the third light.

The configuration described in Additional Remark 14 can use color light the amount of which is likely to be relatively insufficient at increased efficiency, such as the first light output from the first light source, which outputs at least the first light.

(Additional Remark 15) The projector according to Additional Remark 14, wherein the second light modulator includes a second polarization converter configured to change a polarization state of the second light output from the second parallelizing element, and a second polarization separator configured to transmit at least part of a second polarized component of the second light passing through the second polarization converter and reflect another part of the second light, and the second polarization converter is configured to change a polarization state of the other part of the second light reflected off the second polarization separator.

The configuration described in Additional Remark 15, in which the second polarized component of the second light is converted by the second light modulator into the image light, which is used to form an image based on the image light output from the optical module, can increase the efficiency at which the second light is used in addition to the efficiency at which the first light is used.

(Additional Remark 16) The projector according to Additional Remark 14, wherein the first light is red light, the first light modulator includes the first polarization converter, the second light modulator does not include a polarization converter configured to change a polarization state of the second light output from the second parallelizing element, and the third light modulator does not include a polarization converter configured to change a polarization state of the third light output from the third parallelizing element.

The configuration described in Additional Remark 16 allows color light the amount of which is likely to be relatively insufficient to be reliably used at increased efficiency, such as the first light output from the first light source.

(Additional Remark 17) The projector according to Additional Remark 15, wherein the second polarization converter is configured with a quartz crystal substrate, the quartz crystal substrate is configured with a third quartz crystal substrate and a fourth quartz crystal substrate, the third quartz crystal substrate has a third crystal axis, the fourth quartz crystal substrate has a fourth crystal axis, the second polarization converter has a transmission axis, and when viewed along an optical axis of the second light entering the second light modulator, an angle between the third crystal axis and the transmission axis is 45°, and an angle between the fourth crystal axis and the transmission axis is 135°.

The configuration described in Additional Remark 17 can increase the amount of phase modulation made by the quartz crystal substrate of the second polarization converter, ensure a relatively wide wavelength band that allows a large amount of phase modulation, and favorably and efficiently change the polarization state of most of the second light entering the quartz crystal substrate of the second polarization converter.

What is claimed is:

1. An optical module comprising:
a first light source configured to output first light having a first wavelength band;
a first light guide having a first light incident end on which the first light output from the first light source is incident and a first light exiting end via which the first light exits, and configured to homogenize in-plane illuminance of the first light;
a first parallelizing element configured to parallelize the first light output from the first light guide; and
a first light modulator configured to modulate the first light output from the first parallelizing element based on image information,
wherein the first light modulator includes
a first polarization converter configured to change a polarization state of the first light output from the first parallelizing element, and
a first polarization separator configured to transmit at least part of a first polarized component of the first light passing through the first polarization converter and reflect another part of the first light, and
the first polarization converter is configured to change a polarization state of the other part of the first light reflected off the first polarization separator.

2. The optical module according to claim 1, further comprising:
a second light source configured to output second light having a second wavelength band different from the first wavelength band;
a third light source configured to output third light having a third wavelength band different from the first wavelength band and the second wavelength band;
a second light guide having a second light incident end on which the second light output from the second light source is incident and a second light exiting end via which the second light exits, and configured to homogenize in-plane illuminance of the second light;
a third light guide having a third light incident end on which the third light output from the third light source is incident and a third light exiting end via which the third light exits, and configured to homogenize in-plane illuminance of the third light;
a second parallelizing element configured to parallelize the second light output from the second light guide;
a third parallelizing element configured to parallelize the third light output from the third light guide;
a second light modulator configured to modulate the second light output from the second parallelizing element based on image information;
a third light modulator configured to modulate the third light output from the third parallelizing element based on image information; and
a light combiner configured to combine the first light output: from the first light modulator, the second light output from the second light modulator, and the third light output from the third light modulator with one another and output the combined light.

3. The optical module according to claim 1, wherein
the first polarization converter is configured with a quartz crystal substrate.

4. The optical module according to claim 3, wherein
the quartz crystal substrate has a crystal axis,
the first polarization separator has a transmission axis, and
an angle between the crystal axis and the transmission axis is greater than 0° but smaller than 90° when viewed along an optical axis of the first light entering the first light modulator.

5. The optical module according to claim 4, wherein
the angle is 45°.

6. The optical module according to claim 5, wherein the first light is red light.

7. The optical module according to claim 5, wherein
a thickness of the quartz crystal substrate ranges from 0.250 mm to 0.650 mm.

8. The optical module according to claim 3, wherein
the quartz crystal substrate is configured with a first quartz crystal substrate and a second quartz crystal substrate integrated with each other,
the first quartz crystal substrate has a first crystal axis,
the second quartz crystal substrate has a second crystal axis,
the first polarization separator has a transmission axis, and
when viewed along an optical axis of the first light entering the first light modulator, an angle between the first crystal axis and the transmission axis is 15°, and an angle between the second crystal axis and the transmission axis is 75°.

9. The optical module according to claim 8, wherein
a thickness of the first quartz crystal substrate ranges from 0.300 mm to 0.400 mm, and
a thickness of the second quartz crystal substrate ranges from 0.100 mm to 0.200 mm.

10. The optical module according to claim 1, wherein
a light incident surface of the first polarization separator on which the first light is incident is in contact with a light exiting surface of the first polarization converter via which the first light exits, and the first polarization separator and the first polarization converter are integrated with each other.

11. The optical module according to claim 1, wherein
the first light guide has a quadrangular cross-sectional shape.

12. The optical module according to claim 1, wherein
a cross-sectional area of the first light exiting end is greater than a cross-sectional area of the first light incident end.

13. The optical module according to claim 11, wherein
when viewed along an optical axis of the first light entering the first light modulator, a light modulation surface of the first light modulator has a quadrangular shape, and a light incident surface of the first polarization separator has a quadrangular shape.

14. A projector comprising:
the optical module according to claim 2; and
a projection system configured to project light output from the optical module,
wherein the first light source includes a first light emitter configured to emit the first light,
the second light source includes a second light emitter configured to emit the second light, and
the third light source includes
a third light emitter configured to emit fourth light, and
a wavelength conversion element configured to convert the fourth light emitted from the third light emitter into the third light.

15. The projector according to claim 14, wherein
the second light modulator includes
a second polarization converter configured to change a polarization state of the second light output from the second parallelizing element, and
a second polarization separator configured to transmit at least part of a second polarized component of the second light passing through the second polarization converter and reflect another part of the second light, and
the second polarization converter is configured to change a polarization state of the other part of the second light reflected off the second polarization separator.

16. The projector according to claim 14, wherein
the first light is red light,
the first light modulator includes the first polarization converter,
the second t modulator does not include a polarization converter configured to change a polarization state of the second light output from the second parallelizing element, and
the third light modulator does not include a polarization converter configured to change a polarization state of the third light output from the third parallelizing element.

17. The projector according to claim 15, wherein
the second polarization converter is configured with a quartz crystal substrate,
the quartz crystal substrate is configured with a third quartz crystal substrate and a fourth quartz crystal substrate,
the third quartz crystal substrate has a third crystal axis,
the fourth quartz crystal substrate has a fourth crystal axis,
the second polarization converter has a transmission axis, and
when viewed along an optical axis of the second light entering the second light modulator, an angle between the third crystal axis and the transmission axis is 45°, and an angle between the fourth crystal axis and the transmission axis is 135°.
